(19) United States
(12) Patent Application Publication
(10) Pub. No.: US 2026/0075473 A1
(43) Pub. Date: Mar. 12, 2026

(54) METHOD AND APPARATUS FOR PREDICTIVE INTER-CELL MOBILITY

(71) Applicant: ELECTRONICS AND TELECOMMUNICATIONS RESEARCH INSTITUTE, Daejeon (KR)

(72) Inventors: Soongi PARK, Daejeon (KR); Jun Sik Kim, Daejeon (KR); Young Jo Ko, Daejeon (KR); Kwang Seon Kim, Daejeon (KR)

(21) Appl. No.: 19/320,849

(22) Filed: Sep. 5, 2025

(30) Foreign Application Priority Data
Sep. 6, 2024 (KR) 10-2024-0121429
Feb. 25, 2025 (KR) 10-2025-0024445
Aug. 4, 2025 (KR) 10-2025-0107109

(51) Int. Cl. H04W 36/00; H04W 16/28

(52) U.S. Cl. CPC H04W 36/0061; H04W 16/28

(57) ABSTRACT

A method of a terminal may comprise: generating input data to be provided to a neural network based on at least one of quality values of a serving cell and a neighbor cell, or quality values of beams belonging to each of the serving cell and the neighbor cell; and performing an inter-cell mobility operation with a base station based on an optimal beam set predicted by the neural network using the input data, cell information corresponding to the optimal beam set, and an activation time determined according to a future time predicted by the neural network.

### CROSS-REFERENCE TO RELATED APPLICATIONS

This application claims priority to Korean Patent Applications No. 10-2024-0121429, filed on Sep. 6, 2024, No. 10-2025-0024445, filed on Feb. 25, 2025, and No. 10-2025-0107109, filed on Aug. 4, 2025, with the Korean Intellectual Property Office (KIPO), the entire contents of which are hereby incorporated by reference.

### BACKGROUND

### 1. Technical Field

The present disclosure relates to a technique for predictive inter-cell mobility in a communication system, and more particularly, to a proactive inter-cell mobility technique utilizing artificial intelligence.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Meanwhile, conventional inter-cell mobility (ICM) schemes may all be reactive-type ICMs that are triggered based on reported past measurement results and/or measurement events. Types of ICM may include a basic handover (HO), a conditional handover (CHO), and a cell switch scheme. The conditional handover may be included in Layer 3 Triggered Mobility (L3TM), and the cell switch may be included in LIL2 Triggered Mobility (LTM). A reactive ICM Type 1 (e.g. basic handover) and a reactive ICM Type 2 (e.g. LTM) may be reactive-type ICMs in which ICM is triggered and executed based on reported past measurement results and/or measurement events.

The reactive ICM Type 1 may work well between macro cells when mobility of a terminal (e.g. UE) is low. However, the reactive ICM Type 1 may cause unintended events when the mobility of the terminal is high, or between high-density micro cells, or in existing or future services (e.g. extended Reality (XR)). For example, such events may include a handover failure (HOF), a radio link failure (RLF), a ping-pong, a throughput loss, a too-late handover, or a too-early handover.

To enhance the robustness of handover in the reactive ICM Type 1, a conditional reactive ICM Type 1-1 (e.g. CHO) has been introduced in Release 16. In Release 18, the reactive ICM Type 2 (e.g. LTM) has been introduced. The introduced reactive ICM Type 2 has been designed to reduce interruption time caused by frequent handovers in high-density micro cell environments. The reactive ICM Type 2 can support fast ICM operations that match rapid variations in radio quality. Currently, LTM supports only intra-central unit (Intra-CU) configurations, and the specification for supporting inter-central unit (Inter-CU) ICM is under update.

Therefore, since the reactive ICM Type 1, the conditional reactive ICM Type 1-1, and the reactive ICM Type 2 are all still based on reactive design principles, they may still cause unintended events and may not be sufficient to significantly improve the robustness of ICM.

### SUMMARY

The present disclosure for resolving the above-described problems is directed to providing methods and apparatuses for predictive inter-cell mobility.

A method of a terminal, according to exemplary embodiments of the present disclosure, may comprise: generating input data to be provided to a neural network based on at least one of quality values of a serving cell and a neighbor cell, or quality values of beams belonging to each of the serving cell and the neighbor cell; and performing an inter-cell mobility operation with a base station based on an optimal beam set predicted by the neural network using the input data, cell information corresponding to the optimal beam set, and an activation time determined according to a future time predicted by the neural network.

The quality values of the beams belonging to each of the serving cell and the neighbor cell may be actual quality values of at least some beams among all beams belonging to each of the serving cell and the neighbor cell, and virtual quality values may be applied as quality values of remaining beams excluding the at least some beams among all the beams.

When a quality value of at least one cell among the serving cell and the neighbor cell is greater than a predetermined threshold for beam power, a predetermined value may be applied as a quality value of at least one of a quality value of the neighbor cell or quality values of at least some beams belonging to the neighbor cell.

The method may further comprise, when the neural network operates on the terminal, transmitting, to the base station, type information of the neural network, the cell information, the optimal beam set, and the activation time; and receiving, from the base station, a command message for the inter-cell mobility operation.

The method may further comprise, when the neural network operates on the base station, transmitting, to the base station, type information of the neural network, information on measured cells including the serving cell and the neighbor cell, quality values of beams belonging to the measured cells, and a beam power pattern, for generation of input data of the neural network; and receiving, from the base station, a command message for the inter-cell mobility operation, wherein a transmission time of the command message may be determined at the base station based on the activation time and a signaling delay time associated with the command message.

The method may further comprise, when the neural network operates on the terminal, in response to the cell information corresponding to the optimal beam set being information on the neighbor cell, transmitting, to the base station, a reserved physical random access channel (PRACH) preamble corresponding to the neighbor cell, wherein a transmission time of the reserved PRACH preamble may be determined in consideration of the activation time and a transmission delay time associated with the reserved PRACH preamble.

The method may further comprise, when the neural network operates on the terminal, in response to the cell information corresponding to the optimal beam set being information on the neighbor cell, transmitting, to the base station, a measurement report for a predetermined number of beams included in the optimal beam set.

A method of a base station, according to exemplary embodiments of the present disclosure, may comprise: acquiring an optimal beam set predicted by a neural network using input data generated based on at least one of quality values of a serving cell and a neighbor cell or quality values of beams belonging to each of the serving cell and the neighbor cell, cell information corresponding to the optimal beam set, and an activation time determined according to a future time predicted by the neural network; and performing an inter-cell mobility operation with a terminal based on the optimal beam set, the cell information corresponding to the optimal beam set, and the activation time.

The quality values of the beams belonging to each of the serving cell and the neighbor cell may be actual quality values of at least some beams among all beams belonging to each of the serving cell and the neighbor cell, and virtual quality values may be applied as quality values of remaining beams excluding the at least some beams among all the beams.

When a quality value of at least one cell among the serving cell and the neighbor cell is greater than a predetermined threshold for beam power, a predetermined value may be applied as a quality value of at least one of a quality value of the neighbor cell or quality values of at least some beams belonging to the neighbor cell.

The method may further comprise, when the neural network operates on the terminal, receiving, from the terminal, the cell information, the optimal beam set, and the activation time; in response to the cell information being information on the neighbor cell, generating a command message for the inter-cell mobility operation; and transmitting the command message to the terminal based on the activation time.

The method may further comprise, when the neural network operates on the base station, before the acquiring of the optimal beam set, the cell information corresponding to the optimal beam set, and the activation time, receiving, from the terminal, type information of the neural network, information on measured cells including the serving cell and the neighbor cell, quality values of beams belonging to the measured cells, and a beam power pattern; and generating the input data based on the information on the measured cells, the quality values of beams belonging to the measured cells, and the beam power pattern.

The performing of the inter-cell mobility operation may comprise: in response to the cell information corresponding to the optimal beam set being information on the neighbor cell, generating a command message for the inter-cell mobility operation; determining a transmission time of the command message based on the activation time and a signaling delay time associated with the command message; and transmitting the command message to the terminal at the determined transmission time.

The method may further comprise, when the neural network operates on the base station, receiving a reserved physical random access channel (PRACH) preamble from the terminal; in response to the cell information corresponding to the optimal beam set matching cell information corresponding to the PRACH preamble, determining a transmission time of a random access response (RAR) based on the activation time and a signaling delay time associated with the RAR; and transmitting the RAR to the terminal at the determined transmission time.

A terminal according to exemplary embodiments of the present disclosure may comprise at least one processor, and the at least one processor may cause the terminal to perform: generating input data to be provided to a neural network based on at least one of quality values of a serving cell and a neighbor cell, or quality values of beams belonging to each of the serving cell and the neighbor cell; and performing an inter-cell mobility operation with a base station based on an optimal beam set predicted by the neural network using the input data, cell information corresponding to the optimal beam set, and an activation time determined according to a future time predicted by the neural network.

The quality values of the beams belonging to each of the serving cell and the neighbor cell may be actual quality values of at least some beams among all beams belonging to each of the serving cell and the neighbor cell, and virtual quality values may be applied as quality values of remaining beams excluding the at least some beams among all the beams.

When the neural network operates on the terminal, the at least one processor may cause the terminal to perform: transmitting, to the base station, type information of the neural network, the cell information, the optimal beam set, and the activation time; and receiving, from the base station, a command message for the inter-cell mobility operation.

When the neural network operates on the base station, the at least one processor may cause the terminal to perform: transmitting, to the base station, type information of the neural network, information on measured cells including the serving cell and the neighbor cell, quality values of beams belonging to the measured cells, and a beam power pattern, for generation of input data of the neural network; and receiving, from the base station, a command message for the inter-cell mobility operation, wherein a transmission time of the command message may be determined at the base station based on the activation time and a signaling delay time associated with the command message.

When the neural network operates on the terminal, the at least one processor may cause the terminal to perform: in response to the cell information corresponding to the optimal beam set being information on the neighbor cell, transmitting, to the base station, a reserved physical random access channel (PRACH) preamble corresponding to the neighbor cell, wherein a transmission time of the reserved PRACH preamble may be determined in consideration of the activation time and a transmission delay time associated with the reserved PRACH preamble.

When the neural network operates on the terminal, the at least one processor may cause the terminal to perform: in response to the cell information corresponding to the optimal beam set being information on the neighbor cell, transmitting, to the base station, a measurement report for a predetermined number of beams included in the optimal beam set.

According to the present disclosure, through a proactive inter-cell mobility (ICM) based on Artificial Intelligence (AI)/Machine Learning (ML) algorithms, a proactive design rather than a reactive design can be provided, and the robustness of ICM can be significantly improved. Inter-cell mobility performance in at least one of a basic handover, a conditional handover, or a cell switch ICM can be enhanced. The number of handovers can be reduced, and the number of radio link failures can also be decreased. Cases of too-early handover, too-late handover, and incorrect handover can be reduced. Throughput can be increased, and fluctuations in throughput can be reduced.

### BRIEF DESCRIPTION OF DRAWINGS

FIG. 1 is a conceptual diagram illustrating exemplary embodiments of a communication system.

FIG. 2 is a block diagram illustrating exemplary embodiments of an apparatus.

FIG. 3 is a conceptual diagram illustrating cell sizes according to frequency bands.

FIG. 4 is a block diagram illustrating a measurement model of a terminal.

FIG. 5 is a block diagram illustrating a life cycle management (LCM) procedure for an AI/ML model.

FIG. 6 is a block diagram illustrating an inference process of the AI/ML model of FIG. 5.

FIG. 7 is a conceptual diagram illustrating types of AI/ML models.

FIG. 8 is also a conceptual diagram illustrating types of AI/ML models.

FIG. 9 is a conceptual diagram of an AI/ML model for beam management.

FIG. 10 is a conceptual diagram illustrating a signaling procedure for ICM preparation, execution, and completion.

FIG. 11 is a conceptual diagram of an ICM AI/ML model.

FIG. 12 is a flowchart illustrating an AI ICM procedure.

FIG. 13 is a sequence chart illustrating an AI basic handover procedure through inter-cell beam selection.

FIG. 14 is a sequence chart illustrating an AI basic handover procedure through inter-cell beam selection.

FIG. 15 is a sequence chart illustrating a conditional handover procedure through inter-cell beam selection.

FIG. 16 is a sequence chart illustrating a conditional handover procedure through inter-cell beam selection.

FIG. 17 is a sequence chart illustrating a handover LTM procedure through inter-cell beam selection.

FIG. 18 is a sequence chart illustrating a handover LTM procedure through inter-cell beam selection.

FIG. 19 is a graph illustrating cell qualities.

FIG. 20 is a conceptual diagram illustrating relationships between cells and an ICM execution time.

FIG. 21 is a conceptual diagram describing an inter-cell beam selection region and an intra-cell beam selection region within a cell.

FIG. 22 is a conceptual diagram illustrating downlink CBs and FBs.

FIG. 23 is a conceptual diagram illustrating four thresholds.

FIG. 24 illustrates graphs showing opportunities for CBs in the spatial domain.

FIG. 25 illustrates graphs showing opportunities for CBs in the time domain.

FIG. 26 illustrates graphs showing opportunities for FBs in the spatial domain.

FIG. 27 illustrates graphs showing opportunities for FBs in the time domain.

FIG. 28 is a conceptual diagram illustrating CB spatial regions and FB spatial regions.

FIG. 29 illustrates graphs showing beam qualities of individual terminals in the CB sweeping situation of FIG. 28.

FIG. 30 illustrates graphs showing beam qualities of individual terminals in the FB sweeping situation of FIG. 28.

FIG. 31 illustrates a pattern for CB and FB qualities of FIGS. 29 and 30.

FIG. 32 illustrates patterns for CB and FB qualities of FIGS. 29 and 30.

FIG. 33 illustrates patterns for CB and FB qualities of FIGS. 29 and 30.

FIG. 34 is a conceptual diagram illustrating an AI/ML model for ICM.

FIG. 35 is a conceptual diagram illustrating a structure of switches in FIG. 34.

FIG. 36 is a conceptual diagram illustrating input data of a terminal-sided model.

FIG. 37 is a flowchart illustrating a predictive handover procedure using an AI/ML model.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

In the present disclosure, an expression including “when ˜” may be expressed as an expression including “based on ˜” or an expression including “in response to ˜”. In other words, an expression including “when ˜” may be interpreted as being identical or similar to an expression including “based on ˜” or an expression including “in response to ˜”.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be the 4G communication system (e.g. Long-Term Evolution (LTE) communication system or LTE-A communication system), the fifth generation (5G) communication system (e.g. New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

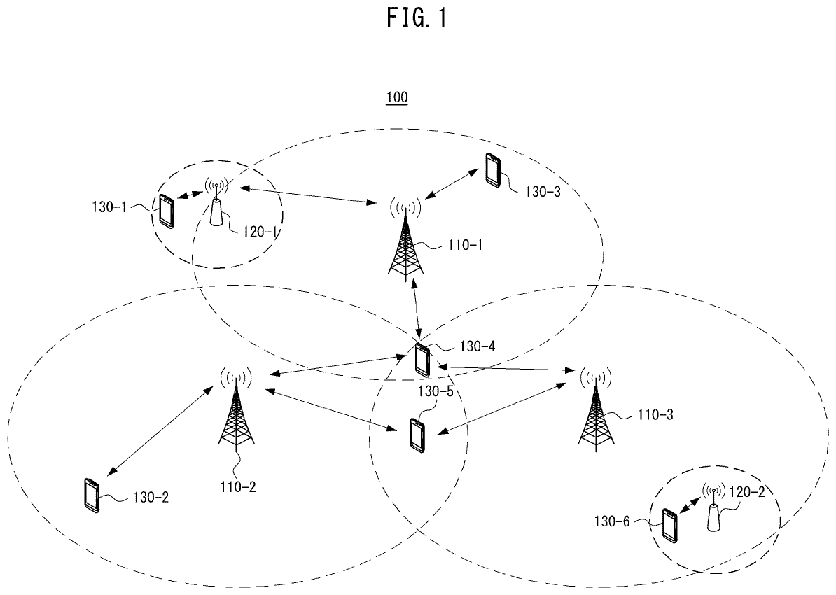

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further comprise a core network (e.g. a serving gateway (S-GW), a packet data network (PDN) gateway (P-GW), and a mobility management entity (MME)). When the communication system 100 is a 5G communication system (e.g. New Radio (NR) system), the core network may include an access and mobility management function (AMF), a user plane function (UPF), a session management function (SMF), and the like.

The plurality of communication nodes 110 to 130 may support communication protocols defined in the 3rd generation partnership project (3GPP) technical specifications (e.g. LTE communication protocol, LTE-A communication protocol, NR communication protocol, or the like). The plurality of communication nodes 110 to 130 may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may mean an apparatus or a device. Exemplary embodiments may be performed by an apparatus or device. A structure of the apparatus (or, device) may be as follows.

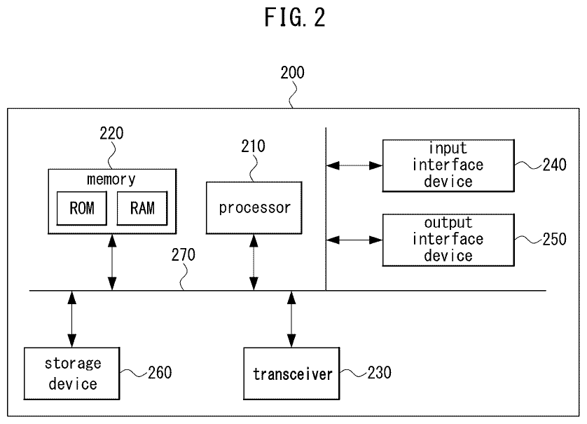

FIG. 2 is a block diagram illustrating exemplary embodiments of an apparatus.

Referring to FIG. 2, an apparatus 200 may comprise at least one processor 210, a memory 220, and a transceiver 230 connected to the network for performing communications. Also, the apparatus 200 may further comprise an input interface device 240, an output interface device 250, a storage device 260, and the like. The respective components included in the apparatus 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g. single-user MIMO (SU-MIMO), multi-user MIMO (MU-MIMO), massive MIMO, or the like), a coordinated multipoint (COMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the COMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

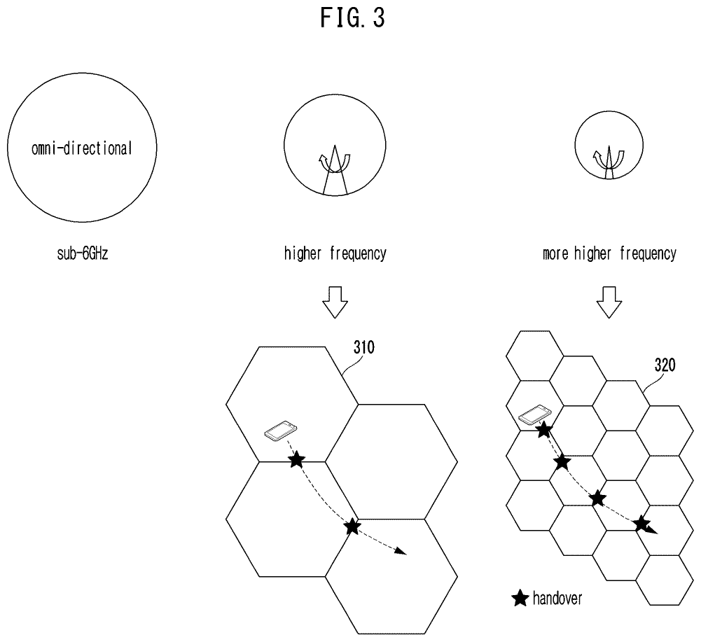

FIG. 3 is a conceptual diagram illustrating cell sizes according to frequency bands.

Referring to FIG. 3, in a communication system, the use of conventional frequencies below 6 GHZ (sub-6 GHZ) and the use of higher frequencies and even higher frequencies may be compared. When higher frequencies and even higher frequencies are used, a communication distance may be reduced, and a concept of a beam may be employed. Appropriate beam selection within a cell (hereinafter referred to as “intra-cell beam selection”) and appropriate beam selection between cells (hereinafter referred to as “inter-cell beam selection”) may have a significant influence on uplink and downlink data throughput (THP) of a terminal. In other words, a large-capacity transmission may be possible in principle because a larger frequency resource can be provided at higher frequencies. However, a service coverage (cell size) 320 for the use of a even higher frequency may be smaller than a service coverage 310 for the use of a higher frequency. As the service coverage decreases and narrower beams are operated, incorrect intra-cell beam selection and inter-cell beam selection may occur more frequently. The frequent beam selection operations may adversely affect throughput. Conversely, when beam selection occurs frequently, optimal intra-cell beam selection and inter-cell beam selection may be achieved. When optimal beam selection becomes possible, throughput may be stably maintained, variation may be reduced, and Quality of Experience (QoE) may be improved.

When an ultra band is used through the utilization of higher and even higher frequency bands, throughput may be significantly improved. However, as the cell size itself becomes smaller, intra-cell beam selection and inter-cell beam selection may be performed frequently. Incorrect intra-cell beam selection and inter-cell beam selection may adversely affect various performance indicators. For example, intra-cell beam selection and inter-cell beam selection may affect throughput and throughput variance (THP variance). The inter-cell beam selection may correspond to inter-cell mobility (i.e. handover or cell switch). The intra-cell beam selection and the inter-cell beam selection may affect performance related to a number of handovers (HO), handover interruption time (HIT), handover failure (HOF), too-early handover (TE HO), too-late handover (TL HO), wrong handover (WHO), radio link failure (RLF), and ping-pong (PP).

For example, a higher frequency band may have characteristics of narrow beams, small cells, and an ultra-dense network (UDN). A even higher frequency band may have characteristics of narrower beams, smaller cells, and a more advanced UDN than those of a higher frequency band. In the even higher frequency band than in the higher frequency band, throughput, the number of handovers, the frequency of occurrence of HIT, RLF, HOF, and PP, and the frequency of TE/TL/W HO may increase, and throughput variation may become larger.

Table 1 is provided to describe types of inter-cell beam selection. The present disclosure relates to inter-cell beam selection, that is, inter-cell mobility (ICM) such as a basic handover, a CHO handover, and a cell switch (LTM). The present disclosure provides an extended concept of intra-cell beam selection using Artificial Intelligence (AI). Through inter-cell beam selection using AI, a throughput average value may be increased, and a throughput variation may be reduced. The present disclosure provides a rational inter-cell beam selection-based ICM method that can guide performance-related indicators (e.g. number of HOs, HIT, HOF, TE/TL/W HO, RLF, PP) in a desirable direction.

The legacy ICM (e.g. handover (basic, conditional) or LTM) may be defined as a reactive ICM. The reactive ICM may be a type of ICM that reacts to an event when the event occurs. The legacy ICM scheme may operate well when a terminal (e.g. UE) has low mobility or when ICM is performed between macro cells. The legacy ICM scheme may cause unintended events in new environments (e.g. an environment in which terminal mobility is high and/or a high-density micro cell environment). The legacy ICM scheme may also cause unintended events in existing or future services (e.g. extended Reality (XR)). The unintended events may include at least one of a handover failure (HOF), a radio link failure (RLF), a ping-pong, a throughput loss, a too-late handover (TL HO), and a too-early handover (TE HO). To resolve the above-described problems, a proactive or predictive ICM method using Artificial Intelligence (AI) is proposed in the present disclosure. In other words, three types of ICM schemes (e.g. AI ICM basic handover, AI ICM conditional handover, and AI ICM-LTM) may be presented. In each scheme, two types of related signaling schemes may be presented depending on whether an AI/Machine Learning (ML) model exists at a terminal side or a network side.

TABLE 1
Inter-cell beam selection (Inter-cell mobility)

| | |
|---|---|
| Handover | LTM |

| | | |
|---|---|---|
| AI basic | AI conditional | AI cell |
| handover | handover | switch |

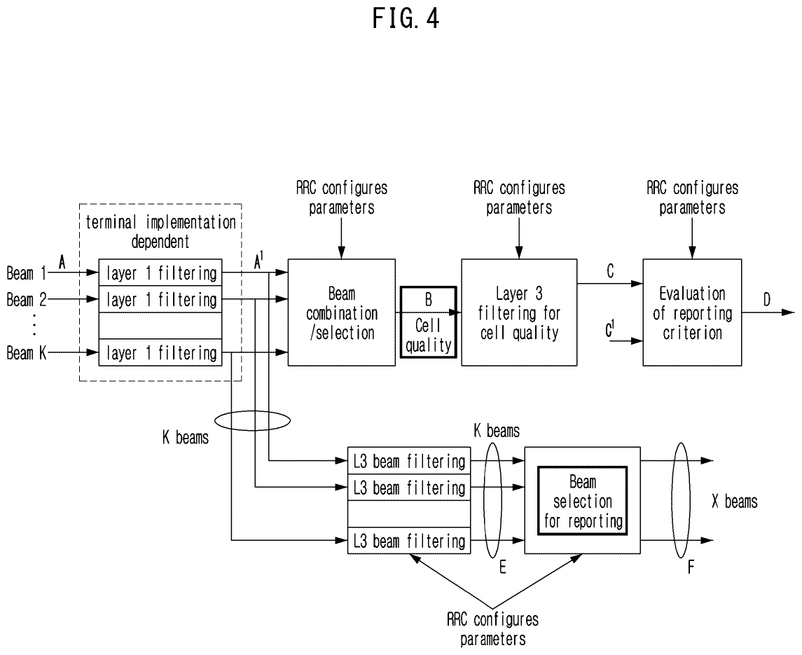

FIG. 4 is a block diagram illustrating a measurement model of a terminal.

Referring to FIG. 4, a terminal may measure beam qualities for beams within a currently connected cell and beams of neighbor cells. L1 or L3 filtering may be performed for each beam. The terminal may combine qualities of beams belonging to one cell and measure a cell quality of the corresponding cell. The intra-cell beam selection may be performed based on L1 measurement per beam. In the case of inter-cell beam selection, various events may be defined based on the cell quality measurement, and the defined events may be used for ICM (handover). Among the various events, an A3 event may be one example. The A3 event may occur when a quality of a neighbor cell becomes better than a quality of a current serving PCell (SpCell).

The measurement at the terminal may be based on measurement of individual beam qualities (e.g. Reference Signal Received Power (RSRP) or Reference Signal Received Quality (RSRQ)). First, the terminal may measure a cell quality (RSRP or RSRQ) by combining qualities of individual beams belonging to one cell. The terminal may define relationships among cell qualities as various events. Based on the defined events, ICM (handover) may be performed. In other words, the legacy ICM may correspond to a scheme that determines and triggers ICM strictly based on cell quality. In the legacy ICM scheme, beams may be used, and cell qualities based on qualities of all beams belonging to corresponding cells may be utilized. However, when beams are used, it may be preferable to determine ICM only for main beams rather than all beams in the serving cell, and only for main beams rather than all beams in ICM candidate cells.

Table 2 illustrates stages in which intra-cell beam selection and inter-cell beam selection (i.e. ICM) are performed. In the case of intra-cell beam selection, in a preparation stage, Channel State Information-Reference Signal (CSI-RS) (i.e. DL) and Sounding Reference Signal (SRS) (i.e. UL) configurations may be made through L3 signaling. L1 measurement for downlink (DL) CSI-RS beams may be performed at the terminal, and L1 measurement for uplink (UL) SRS beams may be performed at the network. Beam switching may be performed through Downlink Control Information (DCI) of L1 layer or Medium Access Control_Control Element (MAC_CE) of L2 layer. Types of inter-cell beam selection may include basic and conditional (CHO) handovers and an LTM. The preparation, execution, and completion stages may be processed through signaling corresponding to each. The CHO handover method may be a method in which the network prepares multiple cells to hand over to, and the terminal selects a cell to hand over to. The LTM method may be a method of switching a cell through faster signaling by using L1 measurement and MAC_CE of L2 layer to quickly adapt to radio condition changes.

TABLE 2

| | Intra-cell | Inter-cell beam selection (ICM) | | |
|---|---|---|---|---|
| | beam | Handover | | LTM |
| | selection | Basic | CHO | Cell switch |
| Preparation | L3 signaling- | L3 signaling | L3 signaling | L3 signaling |
| | CSI-RS (DL), | | | |
| | SRS (UL) | | | |
| Early | N/A | — | — | DL/UL |
| synchronization | | | | synchronization |
| Execution | L1 | L3 | L3 | L1 |
| | measurement | measurement | measurement | measurement |
| | (DL | L1/2/3 signaling | L1/2 signaling | L2 signaling |
| Completion | measurement is | L3 signaling | L3 signaling | L2/3 signaling |
| | performed as | | | |
| | the terminal, | | | |
| | and UL | | | |
| | measurement is | | | |
| | performed at the | | | |
| | terminal), | | | |
| | L1 DCI/L2 | | | |
| | MAC_CE | | | |

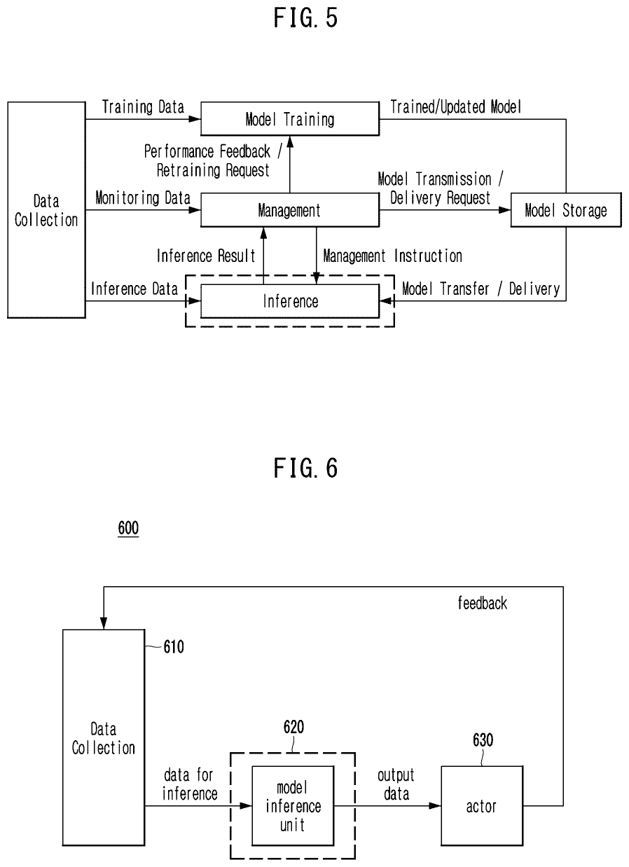

FIG. 5 is a block diagram illustrating a life cycle management (LCM) procedure for an AI/ML model.

Referring to FIG. 5, AI/ML models for CSI compression and prediction, beam management, and positioning are being studied under the leadership of Radio Access Network working group 1 (RAN1). AI/ML models for network energy saving, load balancing, and mobility optimization (i.e. AI/ML models for NG-RAN) are being studied under the leadership of Radio Access Network working group 3 (RAN3). Recently, research on AI/ML models for mobility is in progress. The present disclosure relates to a study on AI/ML for Mobility (i.e. FS_NR_AIML_Mob) that is currently being discussed for mobility under the leadership of Radio Access Network working group 2 (RAN2) in 3GPP. The present disclosure relates to AI ICM for legacy ICM and relates to an inference portion in mobility and in overall AI LCM.

FIG. 6 is a block diagram illustrating an inference process of the AI/ML model of FIG. 5.

Referring to FIG. 6, an AI/ML framework 600 may include a data collection unit 610, a model inference unit 620, and an actor 630. An AI/ML model of the model inference unit may be a trained model that has undergone training. The data collection unit 610 may provide data for inference to the model inference unit 620. In order to obtain a desired result, the data for inference may be input to the AI/ML model. The AI/ML model may determine an action and may output the action as output data. The model inference unit 620 may perform a data preparation stage for the data for inference in addition to inference. The data preparation stage may include at least one of data pre-processing, cleaning, formatting, or transformation, for example. The output data may be input to the actor 630. The actor 630 may receive the output data and may trigger or perform actions for the output data. A result of triggering or performing of the actor 630 may be reflected in the data collection unit 610 in a feedback form.

In the current standard specifications, AI/ML models may be used for beam management, positioning, and CSI compression and prediction or may be used for network energy saving, load balancing, and mobility optimization. In the present disclosure, AI/ML models may be utilized for ICM (conventional basic handover, conditional handover, and LTM), and performance of ICM can be improved.

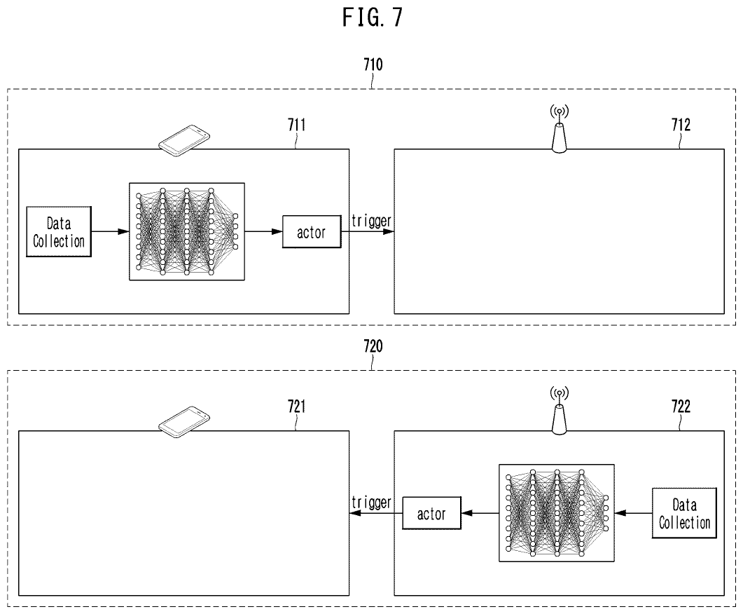

FIG. 7 is a conceptual diagram illustrating types of AI/ML models.

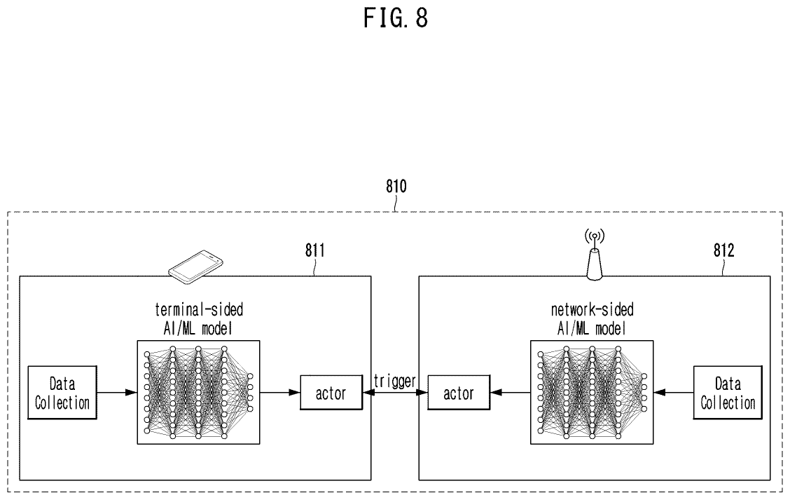

FIG. 8 is also a conceptual diagram illustrating types of AI/ML models.

Referring to FIGS. 7 and 8, AI/ML models may be classified into three types. A first type 710 may be a type in which an AI/ML model is in a terminal 711. Data collection may be performed mainly by the terminal 711. Collected data may be provided as input to the AI/ML model. An output of the AI/ML model may be triggered to a network 712 (i.e. a base station) as an output for ICM.

A second type 720 may be a type in which an AI/ML model is in a network 722. Data collection may be performed mainly by the network 722. Collected data may be provided as input to the AI/ML model. An output of the AI/ML model may be triggered to a terminal 721 as an output for ICM.

A third type 810 may be a type in which an AI/ML model is in both a terminal 811 and a network 812. An operation of the terminal 711 of the first type 710 and an operation of the network 722 of the second type 720 may be performed in the terminal 811 and the network 812, respectively. ICM may be performed through bidirectional signaling (i.e. signaling from the terminal to the network and signaling from the network to the terminal).

Since the AI/ML model of the first type and the AI/ML model of the second type exist on one of the terminal or the network, the AI/ML model of the first type and the AI/ML model of the second type may be referred to as a one-sided AI/ML model. Since the AI/ML model of the third type exists on both the terminal and the network and performs an action, the AI/ML model of the third type may be referred to as a two-sided AI/ML model. Hereinafter, the one-sided AI/ML model may also be referred to as a terminal-sided AI/ML model or an NW-sided AI/ML model.

The AI/ML model may include various internal configurations of at least one or more of Long Short-Term Memory (LSTM), Gated Recurrent Unit (GRU), Temporal Convolutional Network (TCN), Authentication transformer (Authformer), Informer, N-Linear, or an ensemble model. The AI/ML model in the present disclosure may be for prediction of the best inter-cell beam in a current spatial domain and prediction of the best inter-cell beam in a future temporal domain. For prediction, the AI/ML model may be configured as a hybrid model of (Convolutional Neural Network (CNN)+Recurrent Neural Network (RNN) (e.g. LSTM)) in which the CNN and the RNN (e.g. LSTM) are combined.

Table 3 is provided to describe terminal-trigger signaling and network-trigger signaling for inter-cell beam selection (i.e. ICM). Referring to Table 2, Table 3, FIG. 7, and FIG. 8 together, in an ICM basic handover, terminal-trigger signaling may mean signaling in which a measurement report (RRC, L3) is triggered. In the ICM basic handover, network-trigger signaling may mean signaling in which an RRCConnectionReconfiguration (i.e. handover command) (RRC, L3) message is triggered. A time when a message for trigger signaling is triggered may be trained in the AI/ML model. The trained AI/ML model may receive data for inference in practice and may output an action. The terminal and/or the network may improve performance of the ICM handover by determining a time to perform the output action.

Multiple resources may be reserved by the network. The terminal may determine a reserved Random Access Channel (RACH) associated with one of the multiple reserved resources. In an ICM conditional handover, terminal-trigger signaling may mean L1 signaling that is triggered by the terminal through the determined RACH resource. In the ICM conditional handover, network-trigger signaling may mean L2 signaling that is triggered through a Random Access Response (RAR). A time when a message for trigger signaling is triggered may be trained in the AI/ML model. The trained AI/ML model may receive data for inference in practice and may output an action. The terminal and/or the network may improve performance of the ICM handover by determining a time to perform the output action.

In an ICM LTM, terminal-trigger signaling may mean signaling in which an L1 measurement report is triggered. The terminal may not perform all measurement reports. The terminal may report, at a specific time, a beam or possible limited beams determined in the terminal based on an output of the AI/ML model. Network-trigger signaling may be triggered based on a time at which an L2 MAC_CE (e.g. a Cell Switch Command) is transmitted in the network. A trigger signaling scheme in ICM LTM may improve performance of the ICM handover.

TABLE 3
Inter-cell beam selection (Inter-cell mobility)

| | Handover | | LTM |
|---|---|---|---|
| | AI basic handover | AI conditional handover | AI cell switch |
| Terminal | Measurement report (L3) | Reserved RACH (L1) | L1 measurement |
| trigger | | | report |
| | | | L2 MAC_CE |
| Network | Handover command | RAR (L2) | L2 MAC_CE |
| trigger | (RRCConnectionReconfiguration)(L3) | | (cell switch |
| | | | command) |

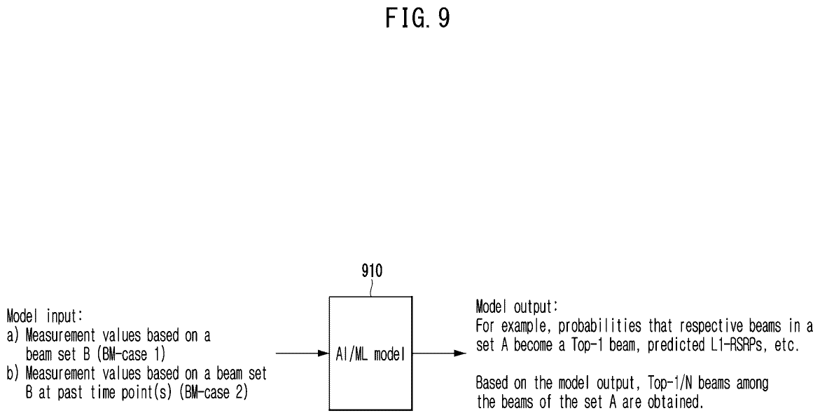

FIG. 9 is a conceptual diagram of an AI/ML model for beam management.

Referring to FIG. 9, an AI/ML model may be a model discussed for beam management (BM) under the leadership of RAN1. From the perspective of intra-cell beam selection, two cases (i.e. BM-case 1 and BM-case 2) may be considered. Table 4 is provided to describe characteristics of the two cases. Referring to FIG. 9 and Table 4 together, in BM-case 1, an AI/ML model 910 for BM may receive a beam set B of partial beams among all beams belonging to a corresponding cell as input. The AI/ML model 910 may predict the best (optimal) beam(s) in a set A at a current transmission time in the spatial domain. In BM-case 2, the AI/ML model 910 for BM may receive a beam set B of partial beams among all beams belonging to a corresponding cell as input. The AI/ML model 910 may predict the best beam(s) in a set A at future transmission time(s) in the time domain.

TABLE 4

| Characteristics | BM-case 1(spatial-domain) | BM-case 2(time-domain) |
|---|---|---|
| Prediction | Best beam(s) for current | Best beam(s) for future |
| type | transmission | transmissions |
| Input data | Measurement values from | Past measurement values |
| | beams of the set B | from beams of the set B |
| Output data | Best beam(s) in the set A | Best beam(s)for future |
| | | times in the set A |

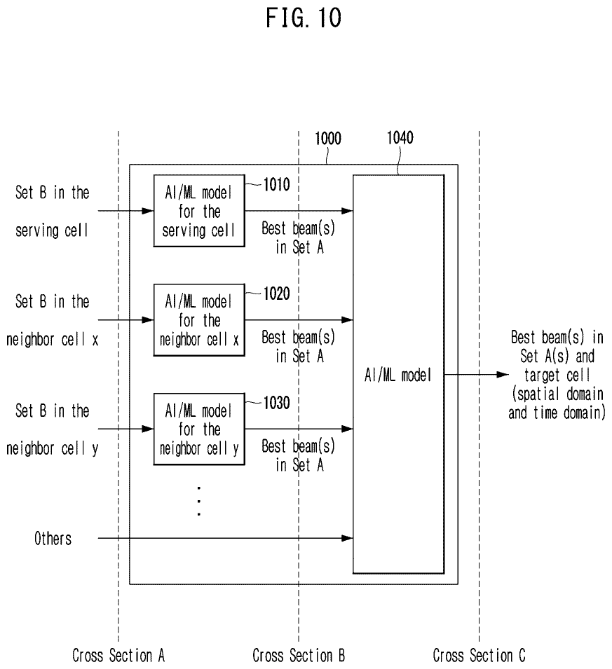

FIG. 10 is a conceptual diagram illustrating a signaling procedure for ICM preparation, execution, and completion.

Referring to FIG. 10, based on the AI/ML model of FIG. 9, BM may be extended when intra-beam selection is performed. AI/ML models 1000 for ICM may include an AI/ML model 1010 for a serving cell, AI/ML model 1020 or 1030 for at least one neighbor cell, and an AI/ML model 1040 for inter-beam selection and ICM. The AI/ML models 1010, 1020, and 1030 may be for intra-beam selection.

In addition to the AI/ML model 1010 for the serving cell under the leadership of RAN1, inter-cell beam selection in neighbor cells (e.g. x and y) may be considered. When inter-cell beam selection is considered, an AI/ML model for the corresponding neighbor cell may additionally operate. For the serving and neighbor cells, each AI/ML model 1010, 1020, or 1030 for each cell may receive, as input, a beam set (e.g. set B) of partial beams among all beams belonging to the corresponding cell. Each AI/ML model 1010, 1020, or 1030 may output the best beam(s) in a set A for the corresponding cell.

Outputs of the AI/ML models 1010, 1020, and 1030 may be input to a new AI/ML model 1040 for inter-cell beam selection. The AI/ML model 1040 may predict, for ICM, the best beam among beams spatially at a current time or temporally at a future time, and may predict a target cell to which the corresponding best beam belongs. Parameter values (e.g. weights and biases) of the trained AI/ML models 1010, 1020, and 1030 for BM in the previous stage may be maintained as they are in the AI/ML model 1040 for ICM in the subsequent stage. The AI/ML model 1040 may determine the best beam in the set A for ICM through training. Based on the best beam in the set A, ICM may be performed. Training of the models 1000 as illustrated in FIG. 10 may be referred to as transfer learning.

A concept of cross section may be used when the terminal-sided AI/ML model or the network-sided AI/ML model of FIG. 7 is used. For example, when a network-sided AI/ML model for ICM is used, a cross section A may be selected. When the cross section A is selected, since the terminal needs to quickly and periodically deliver all sets B and corresponding beam qualities for the serving cell and neighbor cell(s) to the network over a wireless link, a considerable signaling overhead may exist.

For example, when a network-sided AI/ML model for ICM is used, a cross section B may be selected. When the cross section B is selected, the terminal may include AI/ML models for BM for the serving cell and neighbor cells. The terminal may deliver only the best beam(s) in the set A, which is an output of the AI/ML model of the terminal, to the network. In other words, compared to the cross section A, in the cross section B, an amount of signaling that the terminal needs to continuously deliver to the network over a wireless link may decrease, thereby reducing signaling overhead.

In the case of a cross section C, an AI/ML model for ICM may operate only in the terminal. In other words, the models 1010, 1020, 1030, and 1040 may all be terminal-sided models. In the case of the cross section C, since a target cell and beam(s) for ICM are determined in the terminal, data for ICM transmitted over a wireless link may not exist. The terminal may deliver only a signal for triggering ICM to the network. According to FIG. 10, the terminal may additionally configure an AI/ML model for new ICM by utilizing an already trained AI/ML model for BM. The terminal may perform ICM by using the new AI/ML model for ICM. According to FIG. 10, types and information of signals may differ according to the cross section. The models 1000 may receive, as input, sets B from the serving cell and neighbor cells. The models 1000 may also receive, as additional input, information such as UE history information.

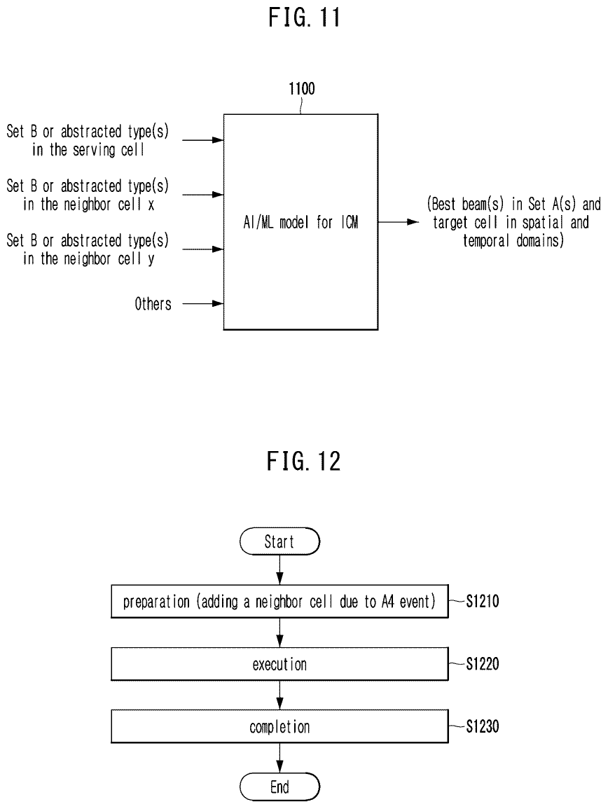

FIG. 11 is a conceptual diagram of an ICM AI/ML model.

Referring to FIG. 11, types and information of signals may be designed according to whether an AI/ML model 1100 is a terminal-sided AI/ML model or a network-sided AI/ML model. When the AI/ML model 1100 is a network-sided AI/ML model, the terminal may need to quickly and periodically deliver, over a wireless link, beam IDs and beam qualities belonging to each set B for a serving cell and neighbor cell(s). When the AI/ML model 1100 is a network-sided AI/ML model, signaling overhead may be large. To avoid signaling overhead, input data itself may be designed in an abstracted form (type). Through the abstracted input data, a frequency and an amount of network-side model inputs may be reduced. In addition to the sets B from the serving cell and neighbor cells or abstracted type data, the model 1100 may selectively receive other information, for example, UE history information, as input.

Inputs of the AI/ML model for ICM in FIGS. 10 and 11 may include at least one of measured RSRPs (or RSRQs), a measured terminal location, or measured UE cell history information. For example, the input data may be L3-filtered RSRP (or RSRQ) values. In a first case, L3-filtered data may be data filtered based on an L1-filtered result and a most recently skipped (i.e. unreported) measurement result. In a second case, L3-filtered data may be an L1-filtered result. In other words, in the second case, L3 filtering may not be separately performed. In a third case, L3-filtered data may be data filtered based on an L1-filtered result and a most recent actual measurement result (i.e. ignoring intermediate skipped result).

From the terminal perspective, in the case of an intra-cell area, measurement results of a single cell may be provided as input to the AI/ML model according to a single-cell approach. From the terminal perspective, in the case of an inter-cell area, measurement results of two or more cells may be provided as input to the AI/ML model.

From the measurement perspective, raw data may be an L1 measurement value for each time duration. The raw data may be L1-filtered. The L1-filtered measurement value may be L3-filtered. As a result of L3 filtering, an L3 measurement value may be obtained. In other words, measurement values may exist in three stages. A measurement value of the first stage may be an L1 measurement value measured at each measurement time duration. A measurement value of the second stage may be an L1-filtered measurement value. A measurement value of the third stage may be an L3-filtered measurement value.

In the second case, the L1-filtered measurement value and the L3-filtered measurement value may be identical. A measurement value processing scheme such as the second case may include a sliding type and a non-sliding type. For the sliding type, the L1-filtered measurement value and the L3-filtered measurement value may be identically generated for each L1 measurement period. For the non-sliding type, the L1-filtered and L3-filtered measurement values may be calculated for each measurement period longer than an L1 measurement duration by using (or by operating on) current and previous L1 measurement values.

An output of the AI/ML model for ICM in FIGS. 10 and 11 may include at least one of a predicted beam and cell information at a future time, predicted measurement quality information (e.g. RSRP, RSRQ information) for beams and cells at a future time, an event at a future time, or predicted UE cell history information at a future time.

For example, there may be two methods for prediction of measurement quality for beams and cells at a future time. A first method may be a method of performing measurement for a certain duration and prediction for a certain duration based on a generation periodicity of filtered L1 measurement values and filtered L3 measurement values. In other words, the first method may not predict measurement quality each time, and a model may attempt output in a manner in which measurement and prediction are completely separated. For example, in the first method, measurement may be performed at time indexes 0 and 1 in chronological order, and prediction may be performed at time indexes 2 and 3.

The second method may be a sliding scheme. For example, based on the generation periodicity of the filtered L1 measurement value and the filtered L3 measurement value, measurement may be performed in a certain time duration, and measurement may not be performed in another time duration. Prediction may be performed based on measurement values in time durations within a predetermined range. The predetermined ranges may overlap for each prediction.

For example, measurement, non-measurement, and prediction instances may be assumed. In a first case, in time order, index 0 may match a measurement instance, index 1 may match a non-measurement instance, index 2 may match a measurement instance, and index 3 may match a non-measurement instance. Index 4 may match a measurement instance, and index 5 may match a prediction instance. For example, in a second case, index 2 may match a measurement instance, index 3 may match a non-measurement instance, index 4 may match a measurement instance, index 5 may match a measurement instance, and index 6 may match a prediction instance. The first and second cases may correspond to a situation where instances of the same type (measurement, non-measurement, or prediction) are executed with a time difference of two durations (i.e. two index numbers). Since index 1 and index 3 correspond to non-measurement, a measurement load is reduced, and prediction may be performed every two time durations. Depending on the environment and prediction accuracy, the number of non-measurement indexes or patterns of measurement, non-measurement, and prediction may be diversified.

Fields of Table 5 may represent three types of ICM schemes. The three types of ICM schemes may be AI basic handover (AI basic HO), AI conditional handover (AI CHO), and AI LTM. Records of Table 5 may represent three categories (A. preparation, B. execution, C. completion). Table 5 may represent types of detailed signals and contents of the signals regarding a one-sided model for a terminal or a network as 1A, 2A, and 3A as shown in FIG. 7.

TABLE 5

| | 1. AI basic | 2. AI conditional | 3. AI |
|---|---|---|---|
| | handover | handover | LTM |
| Preparation stage | 1A | 2A | 3A |
| Early | — | — | O |
| synchronization | | | |
| stage | | | |
| Execution | 1B | 2B | 3B |
| Completion | 1C | 2C | 3C |

FIG. 12 is a flowchart illustrating an AI ICM procedure.

Referring to FIG. 12, when an A4 event occurs, AI/ML models for ICM for a serving cell and neighbor cell(s) may operate (S1210). The case in which the A4 event occurs may be, for example, a case where an average quality of a neighbor cell exceeds a certain threshold. Information regarding the neighbor cell in an inter-beam selection area may be added as an input to the AI/ML model. ICM may be executed (S1220) according to an output result of the AI/ML model. Thereafter, ICM may be completed (S1230).

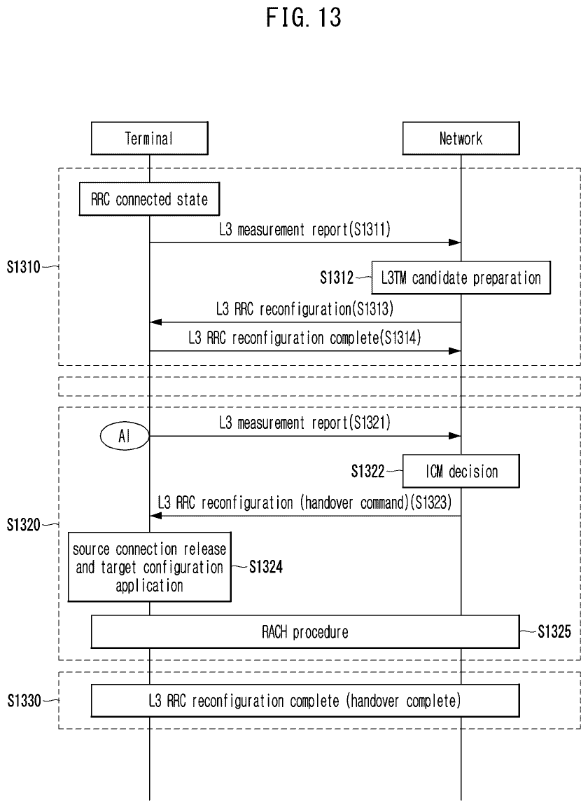

FIG. 13 is a sequence chart illustrating an AI basic handover procedure through inter-cell beam selection.

Referring to FIG. 13, an AI/ML model may be located at a terminal side. The basic handover procedure may include a preparation (1A) stage S1310, an execution (1B) stage S1320, and a completion (1C) stage S1330 as shown in FIG. 12 and Table 5. In the case of FIG. 13, data collection may be performed mainly by the terminal. The collected data may be used as input to the AI/ML model of the terminal for ICM inference. An output of the AI/ML model may be input to an actor and used as signaling for triggering ICM. The trigger may be performed through a measurement report (L3, RRC). The actor may control information included in the measurement report and a time for triggering the measurement report message.

In the preparation stage S1310, the terminal may be in an RRC connected state. The terminal may transmit an L3 measurement report to a network (S1311). The network may receive the L3 measurement report from the terminal. When the network receives the L3 measurement report, the network may start preparing L3 TriggeredMobility (L3TM) candidates (S1312). The network may transmit an L3 RRC reconfiguration message (i.e. L3TM candidate configuration message) to the terminal (S1313). The terminal may receive the L3 RRC reconfiguration message from the network. The terminal may transmit an L3 RRC reconfiguration complete message to the network (S1314). The network may receive the L3 RRC reconfiguration complete message from the terminal.

In the execution stage S1320, the terminal may transmit an L3 measurement report based on an output result of the AI/ML model for ICM to the network (S1321). The network may receive the L3 measurement report based on the output result of the AI/ML model from the terminal. The network may determine ICM (S1322). The network may transmit an L3 RRC reconfiguration message (i.e. handover command) to the terminal (S1323). The terminal may receive the L3 RRC reconfiguration message from the network. The terminal may release a connection with a source cell and apply a configuration of a target cell (S1324). A RACH procedure between the terminal and the network may be performed (S1325). In the completion stage S1330, the L3 RRC reconfiguration between the terminal and the network may be completed. That is, the handover may be completed.

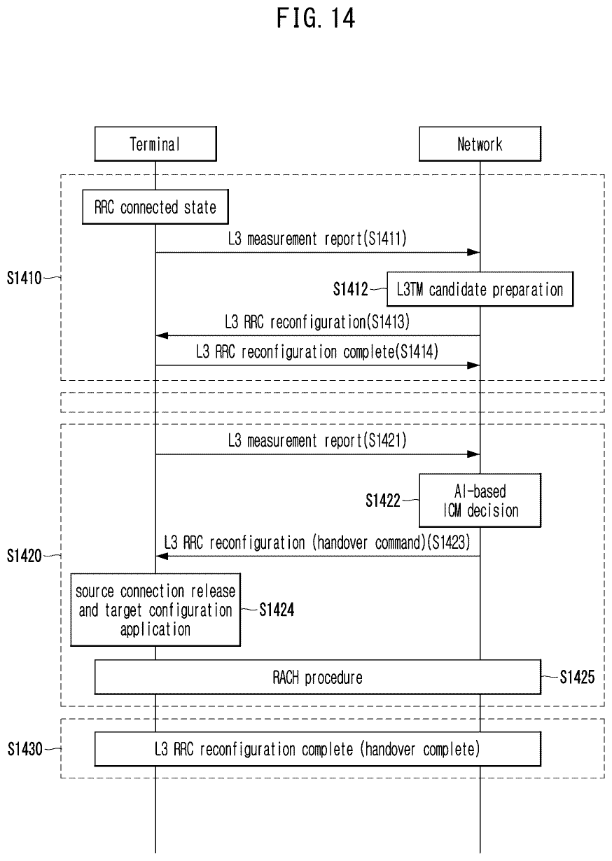

FIG. 14 is a sequence chart illustrating an AI basic handover procedure through inter-cell beam selection.

Referring to FIG. 14, an AI/ML model may be located at a network side. The basic handover procedure may include a preparation (1A) stage S1410, an execution (1B) stage S1420, and a completion (1C) stage S1430 as shown in FIG. 12 and Table 5. In the case of FIG. 14, data collection may be performed mainly by the network. The collected data may be used as input to the AI/ML model of the network for ICM inference. An output of the AI/ML model may be input to an actor and used as signaling for triggering ICM. The trigger may be performed through RRCConnectionReconfiguration (i.e. L3 handover command, RRC). The actor may control information included in the RRCConnectionReconfiguration message and a time for triggering the RRCConnectionReconfiguration message.

Detailed stages S1411, S1412, S1413, and S1414 of the preparation stage S1410 may be identical to the detailed stages S1311, S1312, S1313, and S1314 of the preparation stage S1310 in FIG. 13. Most detailed stages S1421, S1423, S1424, and S1425 of the execution stage S1420 may be identical to the detailed stages S1321, S1323, S1324, and S1325 of the execution stage S1320 in FIG. 13. In the execution stage S1420, the AI/ML model may be located at the network. The network may determine ICM based on an output result of the AI/ML model of the network (S1422). The completion stage S1430 may be identical to the completion stage S1330 in FIG. 13.

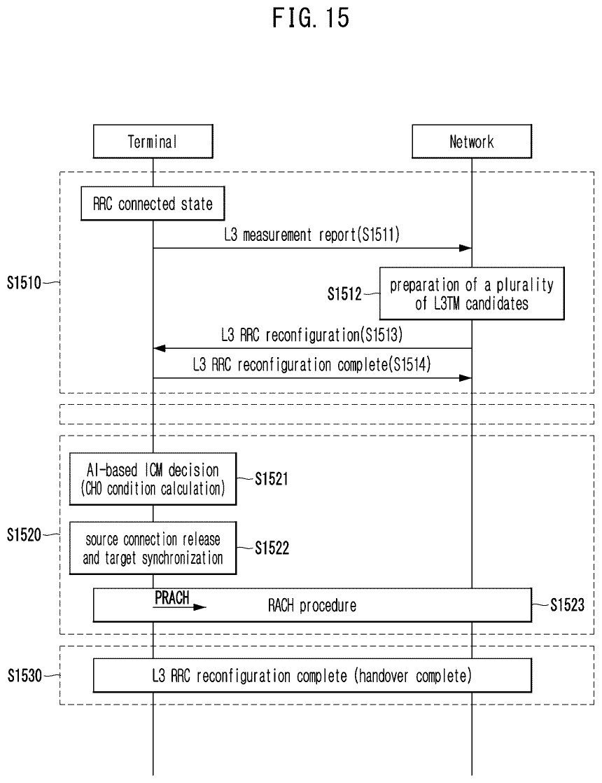

FIG. 15 is a sequence chart illustrating a conditional handover procedure through inter-cell beam selection.

Referring to FIG. 15, an AI/ML model may be located at a terminal side. The conditional handover procedure may include a preparation state (2A) stage S1510, an execution stage (2B) stage S1520, and a completion stage (2C) stage S1530 as shown in FIG. 12 and Table 5. In the conditional handover, the network may assume movement of the terminal to one of N cells. The network may prepare a plurality of candidates (i.e. cell candidates) and provide the terminal with related information regarding the plurality of candidates. While moving, the terminal may have Physical Random Access Channel (PRACH) resources associated with N prepared candidates provided by the network.

In the case of FIG. 15, data collection may be performed centered on the terminal. The collected data may be used as input to the AI/ML model of the terminal for ICM inference. An output of the AI/ML model may be input to an actor and used as signaling for triggering ICM. The trigger may be performed by performing a RACH procedure (L1, PRACH) through reserved PRACHs associated with the plurality of prepared candidates. The actor may control a time for triggering the reserved PRACH.

In the preparation stage S1510, the terminal may be in an RRC connected state. The terminal may transmit an L3 measurement report to the network (S1511). The network may receive the L3 measurement report from the terminal. When the network receives the L3 measurement report, the network may start preparing a plurality of candidates for L3 TriggeredMobility (L3TM) (S1512). The network may transmit an L3 RRC reconfiguration message (i.e. a message regarding L3TM conditional handover configuration(s)) to the terminal (S1513). The terminal may receive the L3 RRC reconfiguration message from the network. The terminal may transmit an L3 RRC reconfiguration complete message to the network (S1514). The network may receive the L3 RRC reconfiguration complete message from the terminal.

In the execution stage S1520, the terminal may determine ICM based on an output result of the AI/ML model (S1521). That is, the terminal may calculate a condition for conditional handover. The terminal may release a connection with a source cell and apply a configuration of a target cell (ex, target synchronization) (S1522). By transmitting the reserved PRACH, a RACH procedure between the terminal and the network may be performed (S1523). In the completion stage (S1530), the L3 RRC reconfiguration between the terminal and the network may be completed. That is, the handover may be completed.

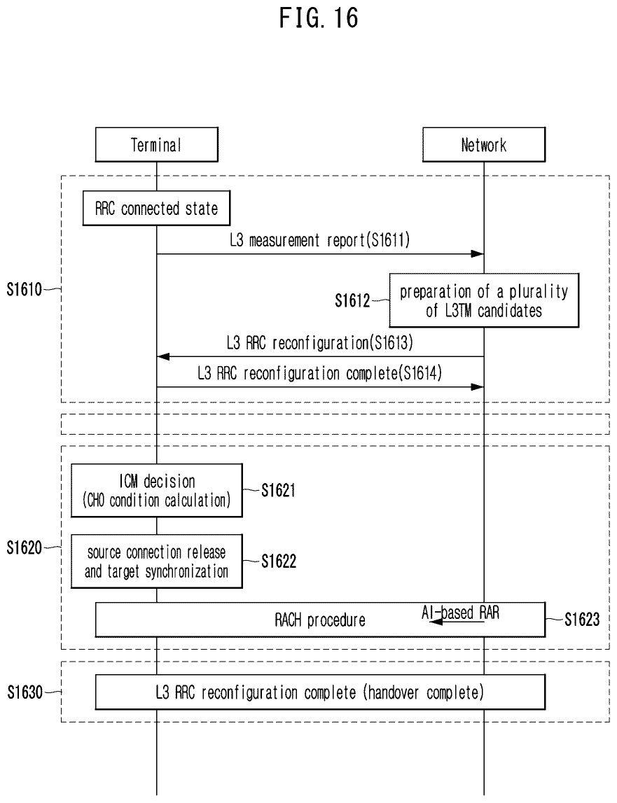

FIG. 16 is a sequence chart illustrating a conditional handover procedure through inter-cell beam selection.

Referring to FIG. 16, an AI/ML model may be located at a network side. The conditional handover procedure may include a preparation (2A) stage S1610, an execution (2B) stage S1620, and a completion (2C) stage S1630 as shown in FIG. 12 and Table 5. In the case of FIG. 16, data collection may be performed mainly by the network. The collected data may be used as input to the AI/ML model of the network for ICM inference. An output of the AI/ML model may be input to an actor and used as signaling for triggering ICM. The trigger may be performed through a Random Access Response (RAR) (L2). The actor may control information included in the RAR and a time for triggering the RAR message.

Detailed stages S1611, S1612, S1613, and S1614 of the preparation stage S1610 may be identical to the detailed stages S1511, S1512, S1513, and S1514 of the preparation stage S1510 in FIG. 15. Since the AI/ML model is located at the network side, the AI/ML model may not be used in the ICM decision S1621 during the execution stage S1620. Detailed stage S1622 of the execution stage S1620 may be identical to the detailed stage S1522 of the execution stage S1520 in FIG. 15. A RACH procedure between the terminal and the network may be performed while the network transmits an RAR according to an output result of the AI/ML model to the terminal (S1623). The completion stage S1630 may be identical to the completion stage S1530 in FIG. 15.

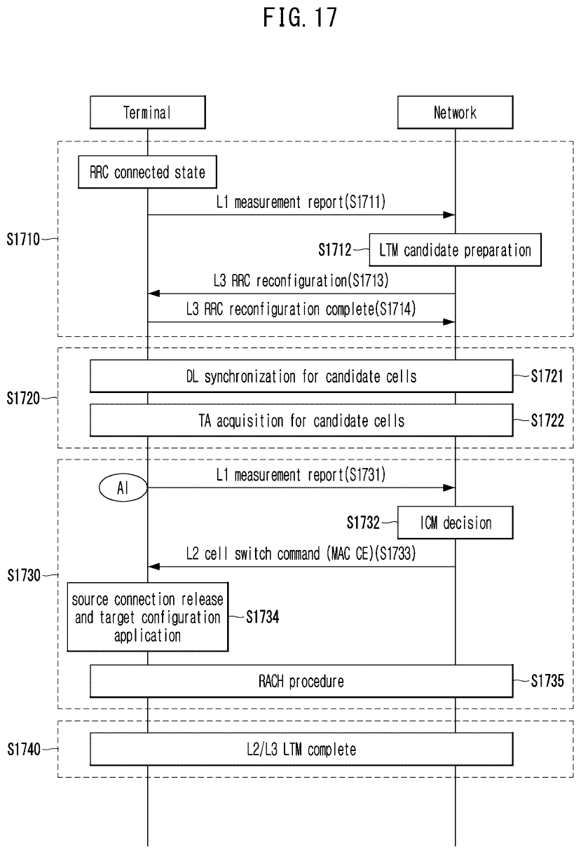

FIG. 17 is a sequence chart illustrating a handover LTM procedure through inter-cell beam selection.

Referring to FIG. 17, an AI/ML model may be located at a terminal side. The LIL2 Triggered Mobility (LTM) procedure may include a preparation (3A) stage S1710, an execution (3B) stage S1730, and a completion (3C) stage S1740 stages as shown in FIG. 12 and Table 5. An early synchronization stage S1720 may be added between the preparation stage and the execution stage. In the preparation stage S1710, the network may perform preparation of LTM candidates for LTM. The terminal and the network may continuously perform DL synchronization and UL synchronization for a target cell through early synchronization (Early Sync). A cell switch may be performed within at least five milliseconds according to a change in radio conditions in a short time. ICM may be performed through an L2 cell switch command (MAC_CE) based on L1 measurements.

In the case of FIG. 17, data collection may be performed mainly by the terminal. The collected data may be used as input to the AI/ML model of the terminal for ICM inference. An output of the AI/ML model may be input to an actor and used as signaling for triggering ICM. The trigger may be performed through an L1 measurement report. The trigger may be performed through an L1 measurement report for one beam or a selected group of beams, rather than all beams in L1 measurements. The actor may control a time for triggering the L1 measurement report message.

In the preparation stage S1710, LTM candidate preparation may be performed differently from the stage S1312 in FIG. 13. The early synchronization stage S1720 may be performed between the preparation stage S1710 and the execution stage S1730. For example, DL synchronization for candidate cells between the terminal and the network may be performed (S1721). Thereafter, TAs for the candidate cells may be obtained (S1722).

In the execution stage S1730, the terminal may transmit an L1 measurement report based on an output result of the AI/ML model for ICM to the network (S1731). The network may receive the L1 measurement report based on the output result of the AI/ML model from the terminal. The network may determine ICM (S1732). The network may transmit an L2 cell switch command in the form of MAC_CE to the terminal (S1733). The terminal may receive the L2 cell switch command from the network. The terminal may release a connection with a source cell and apply a configuration of a target cell (S1734). A RACH procedure between the terminal and the network may be performed (S1735). In the completion stage S1740, L2/L3 LTM between the terminal and the network may be completed.

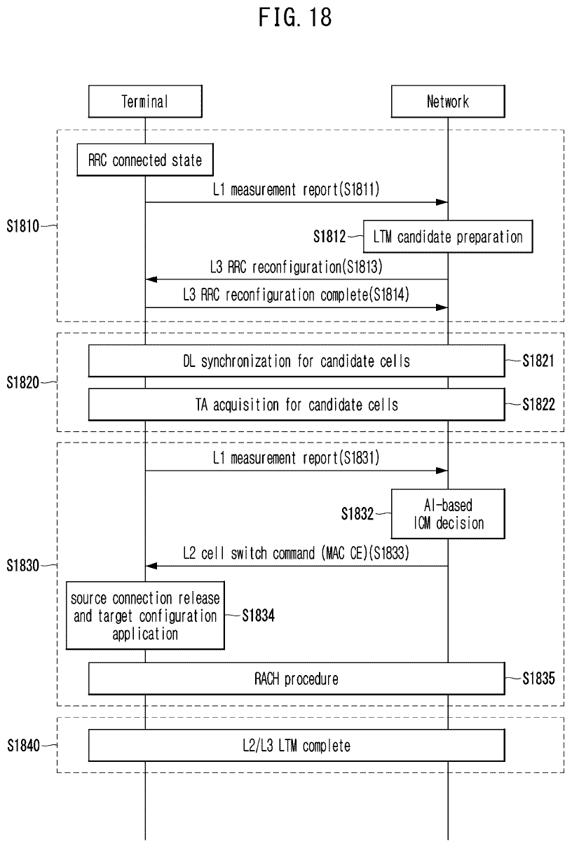

FIG. 18 is a sequence chart illustrating a handover LTM procedure through inter-cell beam selection.

Referring to FIG. 18, an AI/ML model may be located at a network side. The LIL2 Triggered Mobility (LTM) procedure may include a preparation (3A) stage S1810, an execution (3B) stage S1830, and a completion (3C) stage S1840 as shown in FIG. 12 and Table 5. Data collection may be performed centered on the network. The collected data may be used as input to the AI/ML model of the network for ICM inference. An output of the AI/ML model may be input to an actor and used as signaling for triggering ICM. The trigger may be performed through an L2 cell switch command. The actor may control information in the L2 cell switch command message and a timing for triggering the L2 cell switch command message.

Detailed stages S1811, S1812, S1813, and S1814 of the preparation stage S1810, detailed stages S1821 and S1822 of the early synchronization stage S1820, and the completion stage S1840 may be identical to the detailed stages S1711, S1712, S1713, and S1714 of the preparation stage S1710, the detailed stages S1721 and S1722 of the early synchronization stage S1720, and the completion stage S1740 in FIG. 17, respectively. In the execution stage S1830, since the AI/ML model is located at the network, the L1 measurement reporting S1831 may not be AI-based. The network may determine ICM based on an output result of the AI/ML model (S1832). Detailed stages S1833 and S1834 of the execution stage S1830 may be identical to the detailed stages S1733 and S1734 of the execution stage S1730 in FIG. 17.

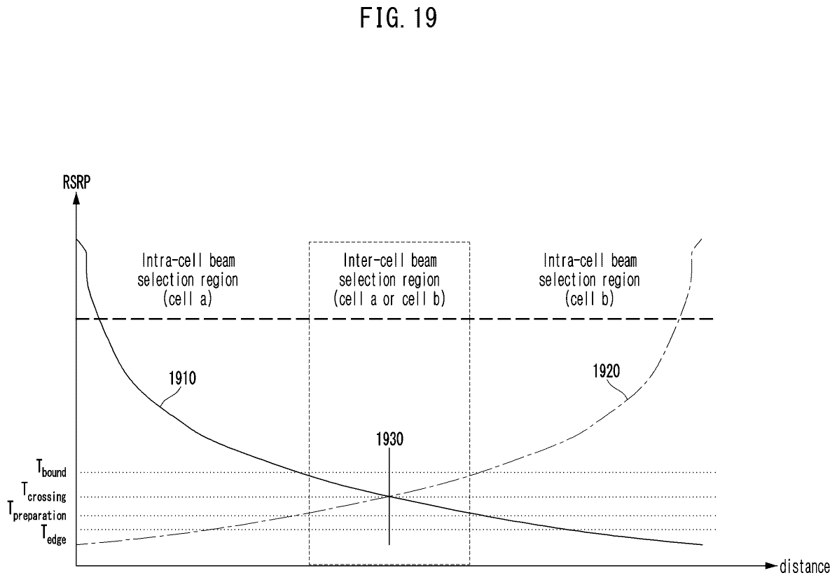

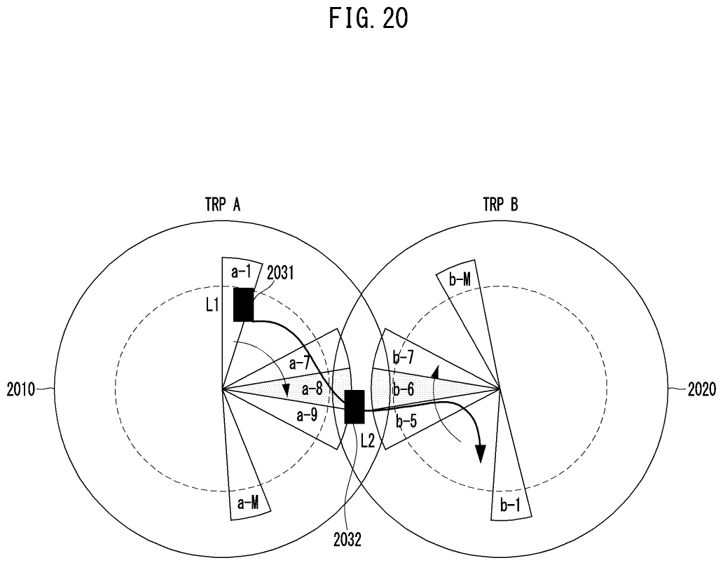

FIG. 19 is a graph illustrating cell qualities.

Referring to FIG. 19, a curve 1910 may be a quality curve for a cell a. A curve 1920 may be a quality curve for a cell b. A horizontal axis of the curves 1910 and 1920 may represent distance. A vertical axis of the curves 1910 and 1920 may represent RSRP. In the legacy ICM (basic HO, CHO), a cell quality may be operated based on four radio quality thresholds (T_{bound}, T_{crossing}, Tₚᵣₑₚₐᵣₐₜᵢₒₙ, T_{edge}).

When RSRP is smaller than the first quality threshold (T_{edge}), signaling for ICM may be impossible. When RSRP is equal to or greater than the first quality threshold (T_{edge}), ICM signaling may be possible. The second quality threshold (T_{crossing}) may mean a reference radio quality value of a point (hereinafter, a crossing point) 1930 where qualities of the two cells (e.g. cells a and b) intersect equally. In other words, the second quality threshold may mean a radio quality value at which ICM may be triggered before or after the crossing point 1930.

When a radio quality of a serving cell is equal to or greater than the third quality threshold (Tₚᵣₑₚₐᵣₐₜᵢₒₙ) and/or a radio quality of a neighbor cell is equal to or less than the third quality threshold (Tₚᵣₑₚₐᵣₐₜᵢₒₙ), the terminal may be determined to be in an intra-beam selection region centered on the current serving cell. When the terminal is determined to be in the intra-beam selection region, ICM may not be considered. When the radio quality of the serving cell is less than the third quality threshold (Tₚᵣₑₚₐᵣₐₜᵢₒₙ) and/or a radio quality of a neighbor cell is greater than the third quality threshold (Tₚᵣₑₚₐᵣₐₜᵢₒₙ), performance of the preparation stage (e.g. the preparation stage in Table 5) for ICM for the corresponding neighbor cell may be triggered. The fourth quality threshold (T_{bound}) may be a threshold radio measurement value that is equal to or greater than the first quality threshold (T_{edge}). The fourth quality threshold may be subdivided into values that define power levels stepwise from a cell center toward a cell edge according to a purpose. For example, the fourth quality threshold may be subdivided into various boundary radio quality measurement values such as a first sub-threshold (T_{high}), a second sub-threshold (T_{medium}), and a third sub-threshold (T_{low}).

In FIG. 19, a cell quality may eventually be a value obtained by combining qualities of beams belonging to the corresponding cell. In a slow ICM such as ICM basic handover or conditional handover, it may be reasonable that ICM is executed based on cell qualities. However, in a fast ICM such as ICM-LTM, it may not be appropriate to execute ICM based on cell qualities. It may be preferable that ICM is executed based on individual qualities of some beams rather than the cell quality corresponding to the combined qualities of the beams.

FIG. 20 is a conceptual diagram illustrating relationships between cells and an ICM execution time.

Referring to FIG. 20, a structural relationship between a cell a 2010 and a cell b 2020 may be at least one of an intra-distributed unit (DU), inter-DU, inter-CU, or inter-base station (BS) relationship. The cell quality in FIG. 4 and FIG. 19 may be a concept of combined qualities of all beams belonging to the corresponding cell. In the preparation stage of ICM, it may be reasonable to perform preparation using the cell qualities in FIG. 4 and FIG. 19. However, in the execution stage of ICM, it may be preferable that the terminal selects several candidate beams and determines a trigger time for ICM execution based on quality information of each selected beam and combined quality information of the corresponding beams.

During the execution stage of the ICM, a terminal 2032 may determine a time for triggering the ICM execution by considering a combined quality from beam (a-1) to beam (a-M) for the cell a 2010 and a combined quality from beam (b-1) to beam (b-M) for the cell b 2020. However, for example, the terminal 2032 may preferably coordinate the time of the ICM execution by considering individual qualities and a combined quality of beam (a-7), beam (a-8), and beam (a-9) for the cell a 2010, and by considering individual qualities and a combined quality of beam (b-5), beam (b-6), and beam (b-7) for the cell b 2020.

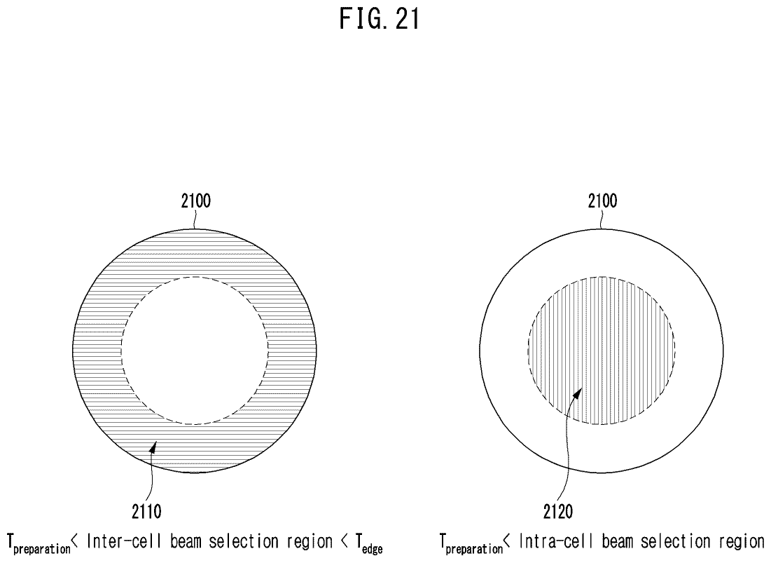

FIG. 21 is a conceptual diagram describing an inter-cell beam selection region and an intra-cell beam selection region within a cell.

Referring to FIGS. 19 to 21, according to the third quality threshold (Tₚᵣₑₚₐᵣₐₜᵢₒₙ), an inter-cell beam selection region 2110 and an intra-cell beam selection region 2120 within one cell 2100 may be distinguished. In the intra-cell beam selection region (i.e. an inner partial region of the cell) 2120, beam selection may continue to be performed within the corresponding serving cell. In the inter-cell beam selection region (i.e. an outer partial region of the cell) 2110, ICM may be performed by an AI L3TM (AI basic HO, AI CHO) or an ICM LTM.

The terminal 2031 located at a location 1 (L1) within the intra-cell beam selection region 2120 may perform only intra-cell beam selection in the corresponding serving cell a 2010 according to the existing AI beam management method. The terminal 2032 located at a location 2 (L2) within the inter-cell beam selection region 2110 may perform inter-cell beam selection for some major beams targeting the cell a 2010 and the cell b 2020, so that ICM may be performed.

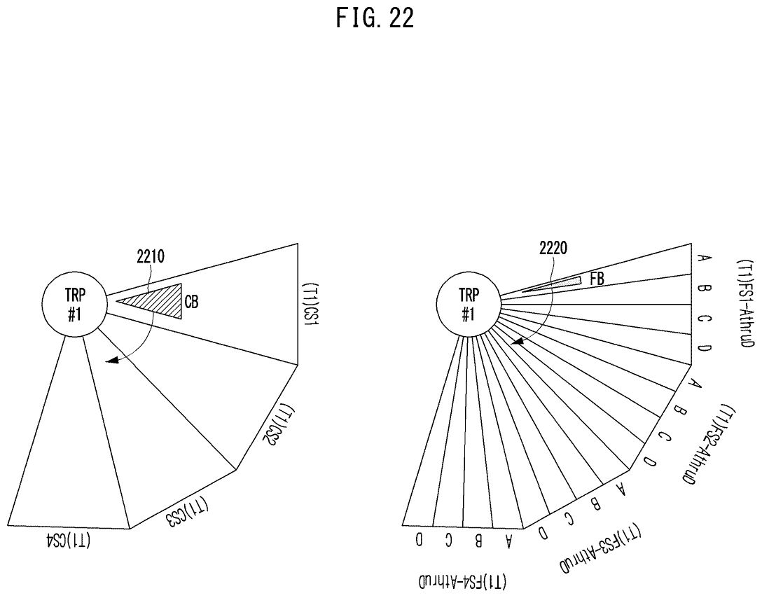

FIG. 22 is a conceptual diagram illustrating downlink CBs and FBs.

Referring to FIG. 22, for example, an SSB may correspond to a coarse beam (CB), and a CSI-RS may correspond to a fine beam (FB). Only one CB 2210 may exist at a specific time. A CB responsible for each region may exist. Each regional CB (or a beam of each regional CB) may have a unique ID. For example, for a TRP T1 (i.e. TRP #1), a coarse beam region (or, coarse beam space, CS) may include a first region ((T1) CS1), a second region ((T1) CS2), a third region ((T1) CS3), and a fourth region ((T1) CS4). A ‘(TX)’ may be added before each of CS1 to CS4. The number ‘X’ may indicate a number of the corresponding TRP. A unique ID of the first region (T1) CS1 may be ID001, and a unique ID of the second region (T1) CS2 may be ID002. A unique ID of the third region (T1) CS3 may be ID003, and a unique ID of the fourth region (T1) CS4 may be ID004.

Only one FB 2220 may exist at a specific time. An FB responsible for each region may exist. For example, for the TRP T1 (i.e. TRP #1), each FB region (or, fine beam space, FS) may be represented as ‘(T1) FS (1/2/3/4)-(A/B/C/D or A through D)’. In ‘T1’, the number ‘1’ may indicate a number of the TRP. A number following FS may indicate a number of a region including one set of detailed regions. One set of detailed regions may include a detailed region A, detailed region B, detailed region C, and detailed region D. Each detailed FB region (or beam of the detailed FB region) may have a unique ID. For example, a unique ID of the detailed region (T1) FS1-A may be ID101, and a unique ID of the detailed region (T1) FS1-B may be ID102. A unique ID of the detailed region (T1) FS2-A may be ID105, and a unique ID of the detailed region (T1) FS3-A may be ID109. A unique ID of the detailed region (T1) FS4-C may be ID115, and a unique ID of the detailed region (T1) FS4-D may be ID116.

During an initial access of a terminal, CBs may be used, and subsequently, FBs may be used. When the terminal is in a connected state, beam management (beam pairing) may mainly be performed through FBs. In a situation such as a radio link failure (RLF), beam failure recovery may again be performed through a CB.

The network may transmit information on CBs to the terminal through system information. The terminal may receive information on CBs through system information from the network. For example, the information on CBs may include at least one of information on a region for a CB (i.e. a beam width (angle information) of one CB), a region-specific beam ID, a total number of CBs, or a rotation direction (left, right). The information on CBs may be useful information for an initial access, beam management, or beam failure recovery.

The network may transmit an L3 layer message (e.g. RRC message) including information on FBs to the terminal through a dedicated signaling channel for the terminal. The information on FBs may include at least one of information on a region for an FB (i.e. a beam width (angle information) of one FB), a region-specific beam ID, a total number of FBs, or a rotation direction (left, right). The information on FBs may be useful information for beam management or beam failure recovery.

Beam management may basically be considered in the spatial domain and the time domain. In terms of intra-cell beam selection, studies are being conducted to reduce overhead, minimize delay, and improve beam selection accuracy by using AI/ML model(s) for beam management. In the present disclosure, by using an AI/ML model for ICM, the accuracy of inter-cell beam selection may be improved, and through the improved accuracy, the performance of ICM may be improved. In the present disclosure, content related to inter-cell beam selection may be described in terms of an extension of intra-cell beam selection.

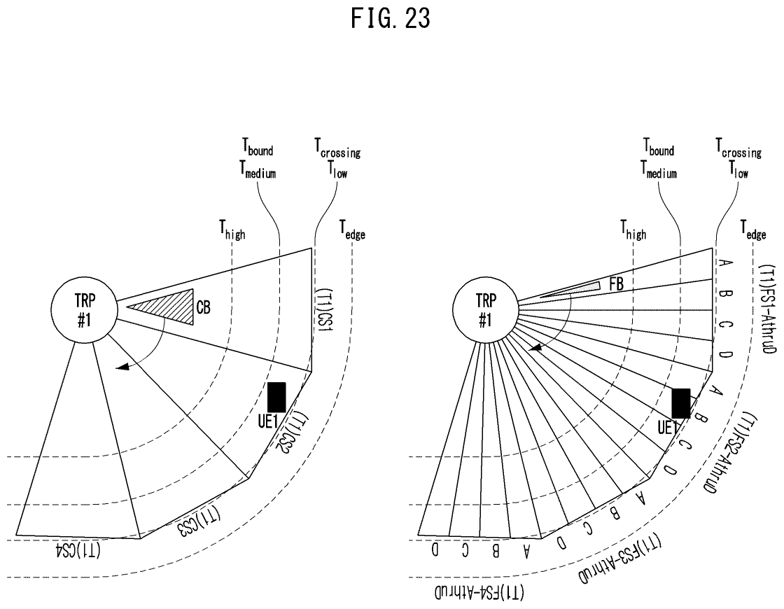

FIG. 23 is a conceptual diagram illustrating four thresholds.

Referring to FIG. 23, a first terminal (UE1) may exist at a specific location in a CB and FB sweeping region. Four different thresholds may be configured from an edge of a cell to a center of the cell with respect to the sweeping region. The four thresholds may be T_{edge}, T_{low}, T_{medium}, and T_{high}. The threshold T_{edge} may be identical to the threshold T_{edge} of FIG. 19. In view of a correspondence with FIG. 19, the threshold T_{low} may correspond to the threshold T_{crossing}, and the threshold T_{medium} may correspond to the threshold T_{bound}.

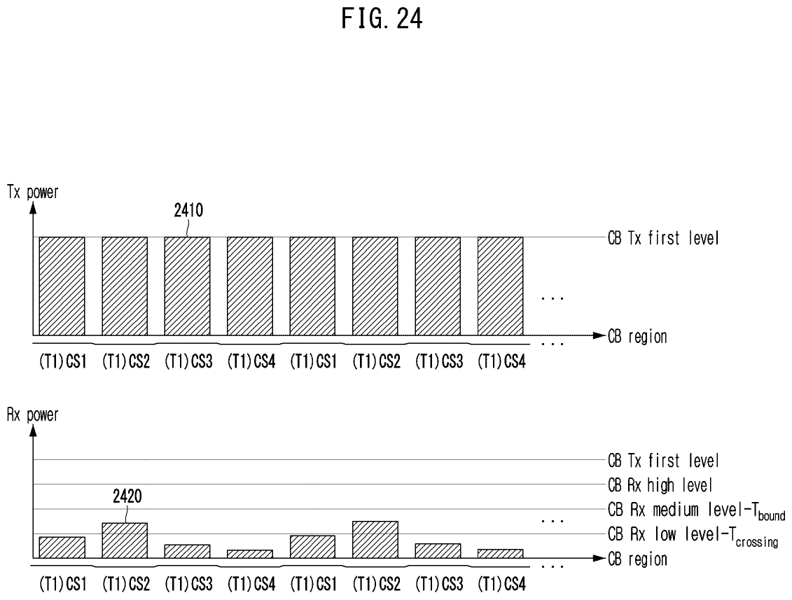

FIGS. 24 to 27 below are graphs for describing how an opportunity (i.e. a time and a region where a specific beam is transmitted and received) is configured in the spatial domain and time domain, respectively, from a TRP aspect and from the first terminal aspect, when the first terminal exists in a certain region of the beam sweeping region, such as in FIG. 23, with respect to a CB and an FB.

FIG. 24 illustrates graphs showing opportunities for CBs in the spatial domain.

Referring to FIG. 24, a graph 2410 may be a graph from a network CB region aspect.

A graph 2420 may be a graph from a terminal CB region aspect. A horizontal axis of the graphs 2410 and 2420 may represent CB regions. The CB region (CS) may be divided into CS1, CS2, CS3, and CS4. The CB region may also be referred to as a CB space. The CB regions may be repeated along the horizontal axis. A vertical axis of the graphs 2410 and 2420 may represent beam powers. The vertical axis of the graph 2410 may represent a network-side transmission (Tx) beam power. The vertical axis of the graph 2420 may represent a terminal-side reception (Rx) beam power.

According to the graph 2410, beam sweeping for the respective CBs may be performed along the respective CSs with the same power from the TRP aspect. Referring to FIGS. 23 and 24, a power of each region-specific beam from the aspect of the first terminal located in CS2 may be shown in the graph 2420. Since the first terminal is located in CS2 and at the edge of the cell, a power of a beam of (T1) CS2 ID002 may be measured to be the greatest. Beams of the remaining regions CS1, CS3, and CS4 may be measured to have lower power than that of the beam of CS2. In other words, a quality of the beam of (T1) CS2 ID002 may be the greatest, power of the beam may exist near the low level (T_{low}, T_{crossing}), and power of the beam may be greater than the low level. Power of surrounding beams may be smaller than the low level (T_{low}, T_{crossing}). Under such conditions, an execution operation for inter-cell beam selection may need to be performed at any time.

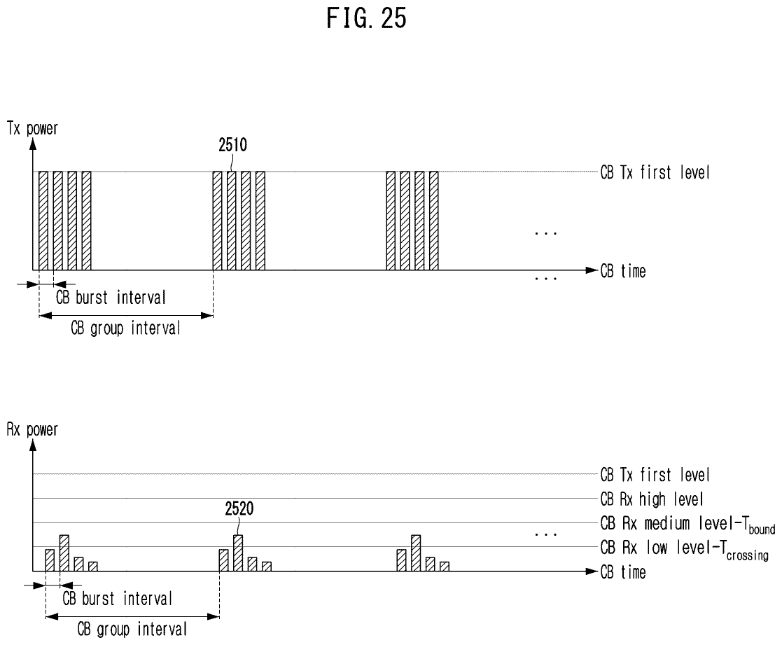

FIG. 25 illustrates graphs showing opportunities for CBs in the time domain.

Referring to FIG. 25, a graph 2510 may be a graph from a network CB time aspect. A graph 2520 may be a graph from a terminal CB time aspect. A horizontal axis of the graphs 2510 and 2520 may represent CB times (coarse beam times). A CB region (or, coarse beam space, CS) may be divided into CS1, CS2, CS3, and CS4. A vertical axis of the graphs 2510 and 2520 may represent beam powers. The vertical axis of the graph 2510 may represent network-side transmission beam powers. The vertical axis of the graph 2520 may represent terminal-side reception beam powers.

According to the graph 2510, from the TRP aspect, the CBs may be swept over time by CSs at the same power. Beam instances may appear differently along a time axis according to a CB group interval and a CB burst interval. Through adjustment of the CB group interval and the CB burst interval, beam sweeping for generating beam instances over time at uniform time intervals based on the CB group interval instead of a burst form may also be performed.

In the graph 2520, a power of each beam by time from an aspect of the first terminal located in CS2 is illustrated. Since the first terminal is located in CS2 and at an edge of the cell, a power of a beam of (T1) CS2 ID002 may be measured to be the greatest. Beams of the remaining regions CS1, CS3, and CS4 may be measured to have lower powers than that of the beam of CS2. In other words, a quality of the beam of (T1) CS2 ID002 may be the greatest, and the power of the beam may exist near the low level (T_{low}, T_{crossing}), and the power of the beam may be greater than the low level. Powers of surrounding beams may be smaller than the low level (T_{low}, T_{crossing}). Under such conditions, an execution operation for inter-cell beam selection may need to be performed at any time.

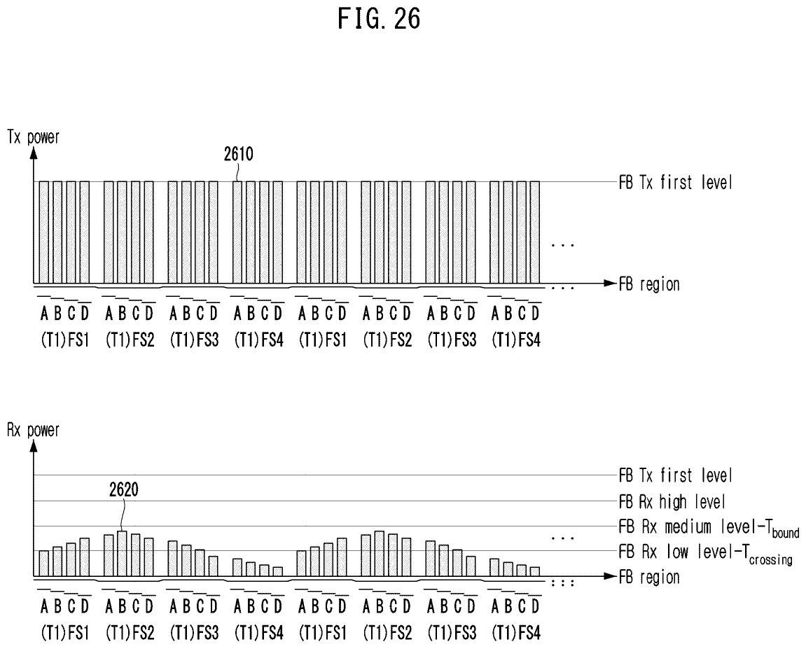

FIG. 26 illustrates graphs showing opportunities for FBs in the spatial domain.

Referring to FIG. 26, a graph 2610 may be a graph from a network FB region aspect. A graph 2620 may be a graph from a terminal FB region aspect. A horizontal axis of the graphs 2610 and 2620 may represent FB regions. An FB region (FS) may be divided into a total of sixteen regions (FS1 (A/B/C/D), FS2 (A/B/C/D), FS3 (A/B/C/D), FS4 (A/B/C/D)). The FB region may also be referred to as an FB space (FS). The FB regions may be repeated along the horizontal axis. A vertical axis of the graphs 2610 and 2620 may represent beam powers. The vertical axis of the graph 2610 may represent network-side transmission beam powers. The vertical axis of the graph 2620 may represent terminal-side reception beam powers.

According to the graph 2610, beam sweeping for the respective FBs may be performed along the respective FSs with the same power from a TRP aspect. Referring to FIGS. 23 and 26, a power of each region-specific beam from an aspect of a first terminal located in FS2-B is illustrated in the graph 2620. Since the first terminal is located in (T1) FS2-B and at an edge of a cell, a power of a beam of (T1) FS2-B ID106 may be measured to be the greatest. Beams of the remaining regions may be measured to have lower powers than that of the beam of FS2-B. In other words, a quality of the beam of (T1) FS2-B ID106 may be the greatest, and the power of the beam may exist near the low level (T_{low}, T_{crossing}), and the power of the beam may be greater than the low level. Powers of surrounding beams may be smaller than the low level. Under such conditions, an execution operation for inter-cell beam selection may need to be performed at any time.

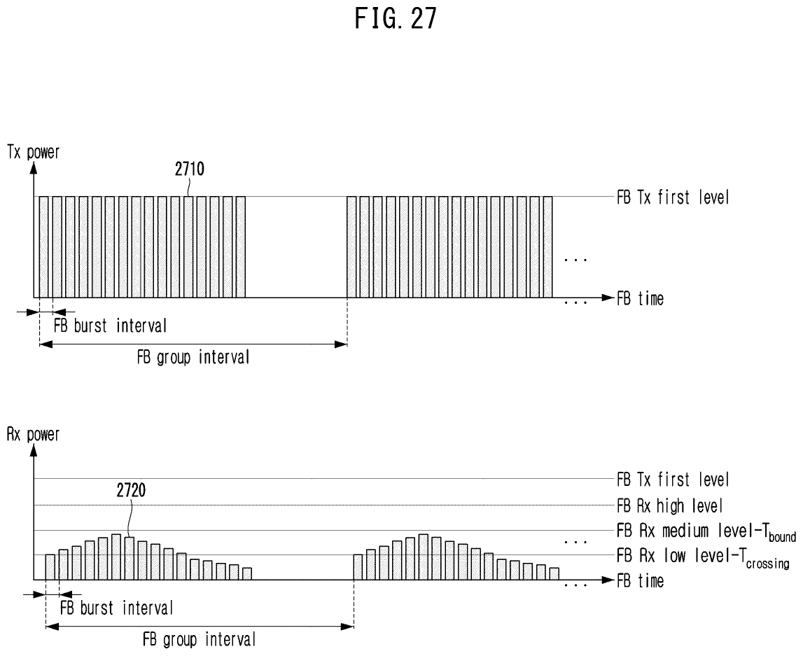

FIG. 27 illustrates graphs showing opportunities for FBs in the time domain.

Referring to FIG. 27, a graph 2710 may be a graph from a network FB time aspect. A graph 2720 may be a graph from a terminal FB time aspect. A horizontal axis of the graphs 2710 and 2720 may represent FB times. An FB region (FS) may be divided into a total of sixteen regions (FS1 (A/B/C/D), FS2 (A/B/C/D), FS3 (A/B/C/D), FS4 (A/B/C/D)). A vertical axis of the graphs 2710 and 2720 may represent beam powers. The vertical axis of the graph 2710 may represent network-side transmission beam powers. The vertical axis of the graph 2720 may represent terminal-side reception beam powers.

According to the graph 2710, from a TRP aspect, the respective FBs may be swept over time by FSs at the same power. Beam instances may appear differently along a time axis according to an FB group interval and an FB burst interval. Through adjustment of the FB group interval and the FB burst interval, beam sweeping for generating beam instances over time at uniform time intervals based on the FB group interval instead of a burst form may also be performed.

In the graph 2720, a power of each beam by time from an aspect of the first terminal located in FS2-B is illustrated. Since the first terminal is located in FS2-B and at an edge of a cell, a power of a beam of (T1) FS2-B ID106 may be measured to be the greatest. Beams of the remaining regions may be measured to have lower powers than that of the beam of FS2-B. In other words, a quality of the beam of (T1) FS2-B ID106 may be the greatest, the power of the beam may exist near the low level, and the power of the beam may be greater than the low level. Powers of surrounding beams may be smaller than the low level. Under such conditions, an execution operation for inter-cell beam selection may need to be performed at any time.

The network may transmit information on CBs to the terminal through system information. The terminal may receive information on CBs through system information from the network. The network may transmit information on FBs to the terminal through a dedicated channel established between the terminal and the network. The terminal may receive information on FBs from the network through the dedicated channel. Based on the information on CBs and the information on FBs received by the terminal, beam-specific quality information for CBs and FBs at the terminal may be linked. The linkage information may be helpful for the terminal to select a beam in the spatial domain and the time domain.

Inputs, outputs, and characteristics of an AI/ML model for Beam Management (BM) may be as shown in Table 4 and FIG. 9. Inputs of the AI/ML model for BM may be information on some beams among beams in a corresponding serving cell. The information on some beams may be information on a set B, for example, beam IDs and qualities (BM-case 1). The information on some beams may be information on a set B, for example, a history for temporal instances and beam qualities (BM-case 2). Outputs of the AI/ML for BM may be predicted qualities (e.g. RSRPs) for beams belonging to a serving cell, and a probability that each beam of a set A becomes an optimal beam. For example, the terminal may group top beams among qualities for beams belonging to each set as the set A. The terminal may obtain probabilities that beams of the set A become the optimal beam. Additionally or alternatively, the terminal may acquire top beams from the beams grouped as the set A.

In other words, BM-case 1 may correspond to prediction of optimal beams of the terminal in the spatial domain at a current time. Input data of the AI/ML model may be measurement information of beams designated as the set B, and output data may be optimal beams determined in a form of the set A. BM-case 2 may correspond to prediction of optimal beams of the terminal in the time domain at future time(s). Input data of the AI/ML model may be measurement values of beams designated as the set B in a time-series form, which is a temporal history form. Output data of the AI/ML model may be optimal beams in a form of the set A at future time instances.

In the serving cell, current beam(s) in the spatial domain may be determined as best DL beams. Additionally or alternatively, in the serving cell, future beam(s) in the time domain may be determined as best DL beams. The present disclosure provides an extended method of an AI/ML model for ICM (i.e. handover (basic/conditional), cell switch) based on a determination method of current and/or future beams.

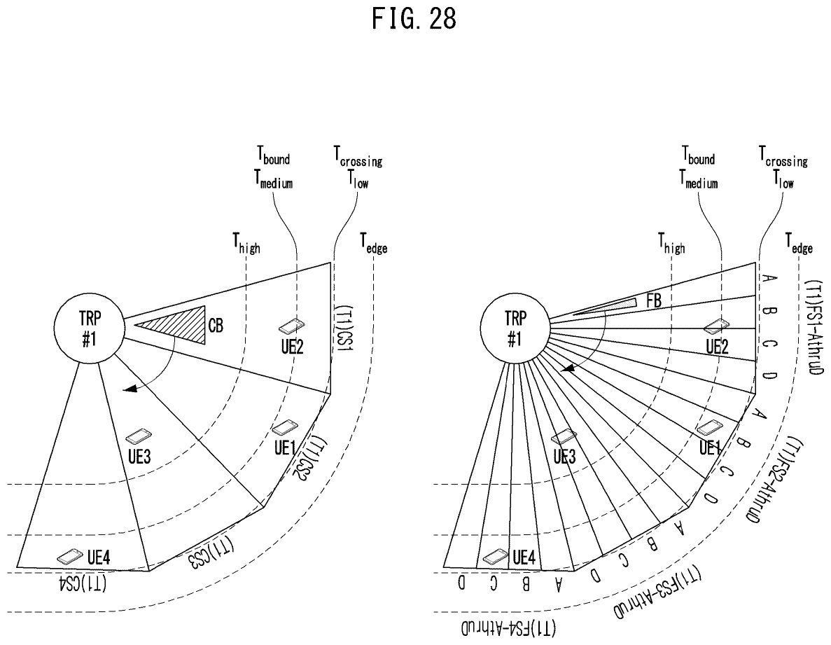

FIG. 28 is a conceptual diagram illustrating CB spatial regions and FB spatial regions.

Referring to FIG. 28, four terminals (UE1, UE2, UE3, UE4) may be arranged in CB spatial regions and FB spatial regions. Beam IDs in the CB spatial regions and the FB spatial regions may be identical to the beam IDs in FIG. 22.

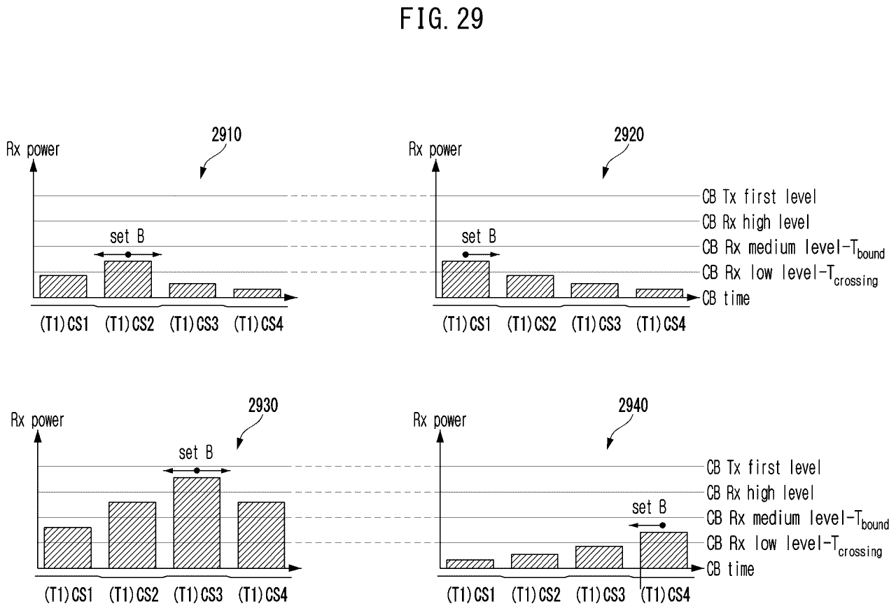

FIG. 29 illustrates graphs showing beam qualities of individual terminals in the CB sweeping situation of FIG. 28.

Referring to FIG. 29, a graph 2910 may be a graph from a CB region aspect of the first terminal UE1. A graph 2920 may be a graph from a CB region aspect of the second terminal UE2. A graph 2930 may be a graph from a CB region aspect of the third terminal UE3. A graph 2940 may be a graph from a CB region aspect of the fourth terminal UE4. The CB region may also be referred to as a CB space (CS). A horizontal axis of the graphs 2910, 2920, 2930, and 2940 may represent CB regions. A CB region (CS) may be divided into CS1, CS2, CS3, and CS4. A vertical axis of the graphs 2910, 2920, 2930, and 2940 may represent a power for a reception beam at a current location of each terminal. A horizontal axis of each graph illustrates a repetition of beam regions. In another exemplary embodiment, the horizontal axis of each graph may represent beams and may be illustrated in a form of instances in the time domain.

Referring to FIG. 28 and the graph 2910 of FIG. 29, the first terminal may be located in CS2. The first terminal may be positioned between the low level (T_{low}, T_{crossing}) and the medium level (T_{medium}, T_{bound}) in terms of power level. Referring to FIG. 28 and the graph 2920 of FIG. 29, the second terminal may be located in CS1. The second terminal may be positioned between the low level (T_{low}, T_{crossing}) and the medium level (T_{medium}, T_{bound}) in terms of power level. Referring to FIG. 28 and the graph 2930 of FIG. 29, the third terminal may be located in CS3. The third terminal may be positioned between the high level and a TRP transmission level (first level) in terms of power level. Referring to FIG. 28 and the graph 2940 of FIG. 29, the fourth terminal may be located in CS4. The fourth terminal may be positioned between the low level (T_{low}, T_{crossing}) and the medium level (T_{medium}, T_{bound}) in terms of power level.

According to current beam measurements, the first terminal may define a set B (001/002/003) with a beam ID (e.g. ID001) of CSI and a beam ID (e.g. ID003) of CS3 based on a beam ID (e.g. ID002) of CS2. According to current beam measurements, the second terminal may define a set B (001/002) with the beam ID (e.g. ID002) of CS2, based on the beam ID (e.g. ID001) of CS1. According to current beam measurements, the third terminal may define a set B (002/003/004) with the beam ID (e.g. ID002) of CS2 and a beam ID (e.g. ID004) of CS4, based on the beam ID (e.g. ID003) of CS3. According to current beam measurements, the fourth terminal may define a set B (003/004) with the beam ID (e.g. ID003) of CS3, based on the beam ID (e.g. ID003) of CS3.

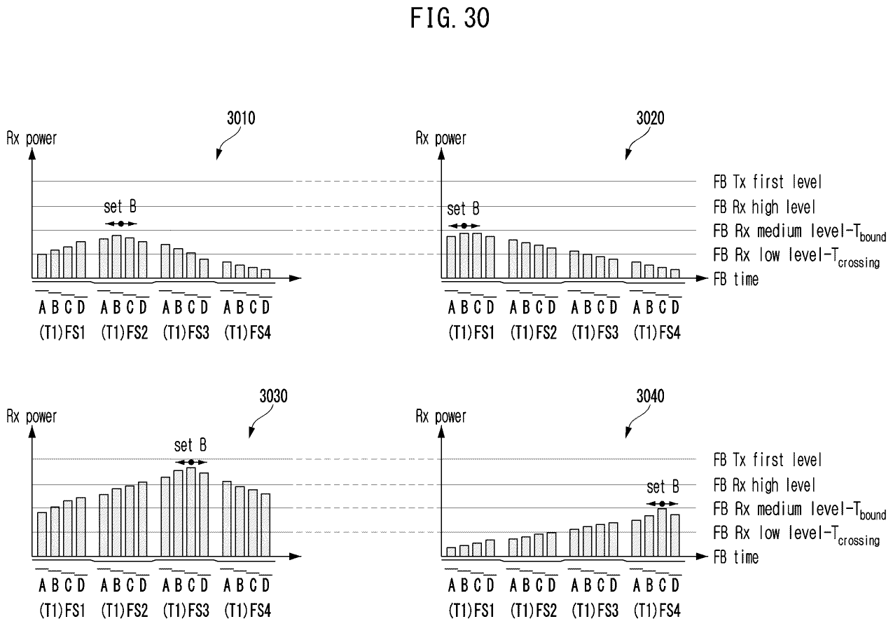

FIG. 30 illustrates graphs showing beam qualities of individual terminals in the FB sweeping situation of FIG. 28.

Referring to FIG. 30, a graph 3010 may be a graph from an FB region (FS) aspect of the first terminal (UE1). A graph 3020 may be a graph from an FB region aspect of the second terminal (UE2). A graph 3030 may be a graph from an FB region aspect of the third terminal (UE3). A graph 3040 may be a graph from an FB region aspect of the fourth terminal (UE4).

The FB region may also be referred to as an FB space (FS). A horizontal axis of the graphs 3010, 3020, 3030, and 3040 may represent FB regions. An FB region may be largely divided into FS1, FS2, FS3, and FS4, and may be subdivided into sixteen regions. A vertical axis of the graphs 3010, 3020, 3030, and 3040 may represent a power for a reception beam at a current location of each terminal. The horizontal axis of each graph illustrates a repetition of beam regions. In another exemplary embodiment, the horizontal axis of each graph may represent beams and may be illustrated in a form of instances in the time domain.

Referring to FIG. 28 and the graph 3010 of FIG. 30, the first terminal may be located in FS2-B. The first terminal may be positioned between the low level (T_{low}, T_{crossing}) and the medium level (T_{medium}, T_{bound}) in terms of power level. Referring to FIG. 28 and the graph 3020 of FIG. 30, the second terminal may be located in a boundary space between FS1-B and FS1-C. The second terminal may be positioned between the low level (T_{low}, T_{crossing}) and the medium level (T_{medium}, T_{bound}) in terms of power level. Referring to FIG. 28 and the graph 3030 of FIG. 30, the third terminal may be located in FS3-C. The third terminal may be positioned between the high level and a TRP transmission level (first level) in terms of power level. Referring to FIG. 28 and the graph 3040 of FIG. 30, the fourth terminal may be located in FS4-C. The fourth terminal may be positioned between the low level (T_{low}, T_{crossing}) and the medium level (T_{medium}, T_{bound}) in terms of power level.

According to current beam measurements, the first terminal may define a set B (105/106/107) with a beam ID (e.g. ID105) of FS2-A and a beam ID (e.g. ID107) of FS2-C, based on a beam ID (e.g. ID106) of FS2-B. According to current beam measurements, the second terminal may define a set B (101/102/103) with a beam ID (e.g. ID101) of FS1-A and a beam ID (e.g. ID103) of FS1-C, based on a beam ID (e.g. ID102) of FS1-B. According to current beam measurements, the third terminal may define a set B (110/111/112) with a beam ID (e.g. ID110) of FS3-B and a beam ID (e.g. ID112) of FS3-D, based on a beam ID (e.g. ID111) of FS3-C. According to current beam measurements, the fourth terminal may define a set B (114/115/116) with a beam ID (e.g. ID114) of FS4-B and a beam ID (e.g. ID116) of FS4-D, based on a beam ID (e.g. ID115) of FS4-C.

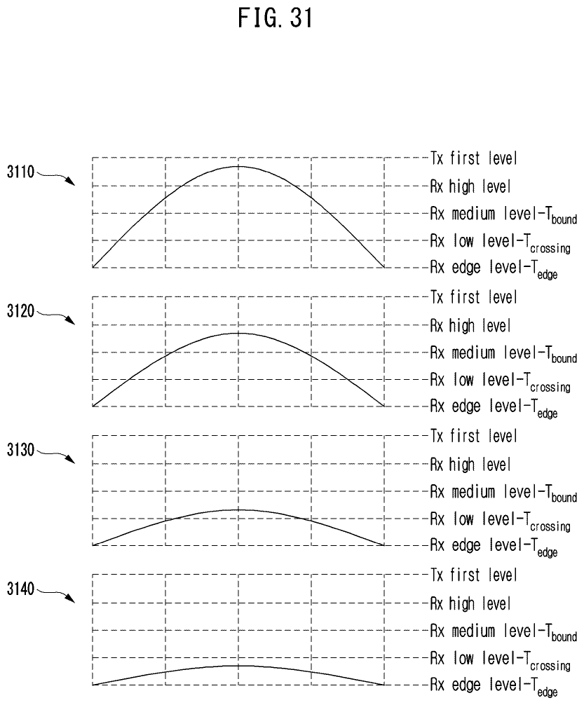

FIG. 31 illustrates a pattern for CB and FB qualities of FIGS. 29 and 30.

Referring to FIG. 31, graphs 3110, 3120, 3130, and 3140 of a first pattern may represent a center pattern in which a beam quality is best near a center. A horizontal axis of the graphs may represent beam spaces. A vertical axis of the graphs may represent beam powers. The graph 3110 may represent a case in which a power of a central beam is greater than the high level. The graph 3120 may represent a case in which a power of a central beam is positioned between the medium level and the high level. The graph 3130 may represent a case in which a power of a central beam is positioned between the low level and the medium level. The graph 3140 may represent a case in which a power of a central beam is positioned between the edge level and the low level.

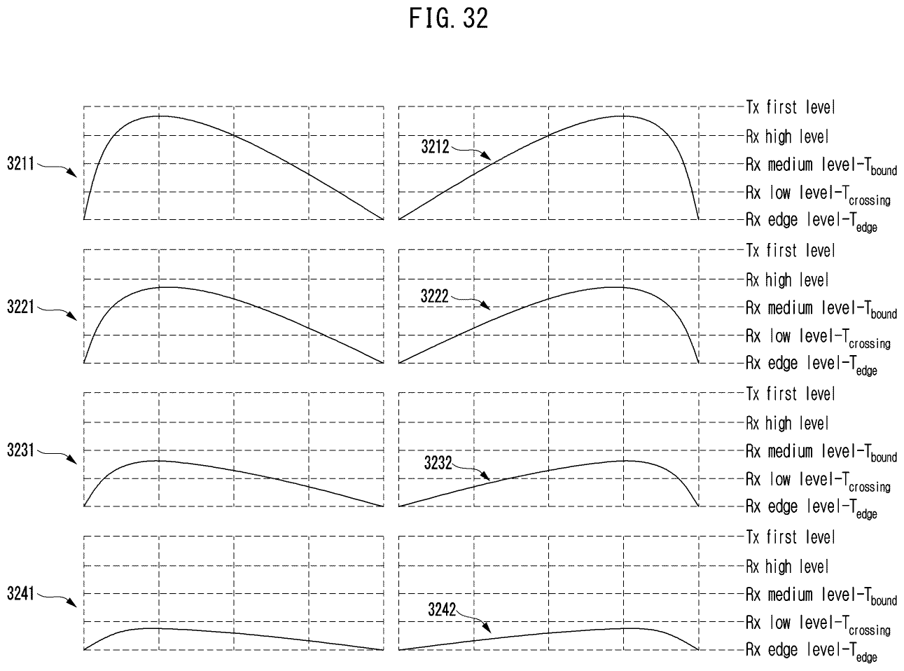

FIG. 32 illustrates patterns for CB and FB qualities of FIGS. 29 and 30.

Referring to FIG. 32, graphs 3211, 3221, 3231, and 3241 of a second pattern may represent a left pattern in which a beam quality is best near a left side. Graphs 3212, 3222, 3232, and 3242 of a third pattern may represent a right pattern in which a beam quality is best near a right side. A horizontal axis of the graphs may represent beam spaces. A vertical axis of the graphs may represent beam powers. The graphs 3211 and 3212 may represent cases in which beam powers on the left and right sides, respectively, are greater than the high level. The graphs 3221 and 3222 may represent cases in which beam powers on the left and right sides, respectively, are positioned between the medium level and the high level. The graphs 3231 and 3232 may represent cases in which beam powers on the left and right sides, respectively, are positioned between the low level and the medium level. The graphs 3241 and 3242 may represent cases in which beam powers on the left and right sides, respectively, are positioned between the edge level and the low level.

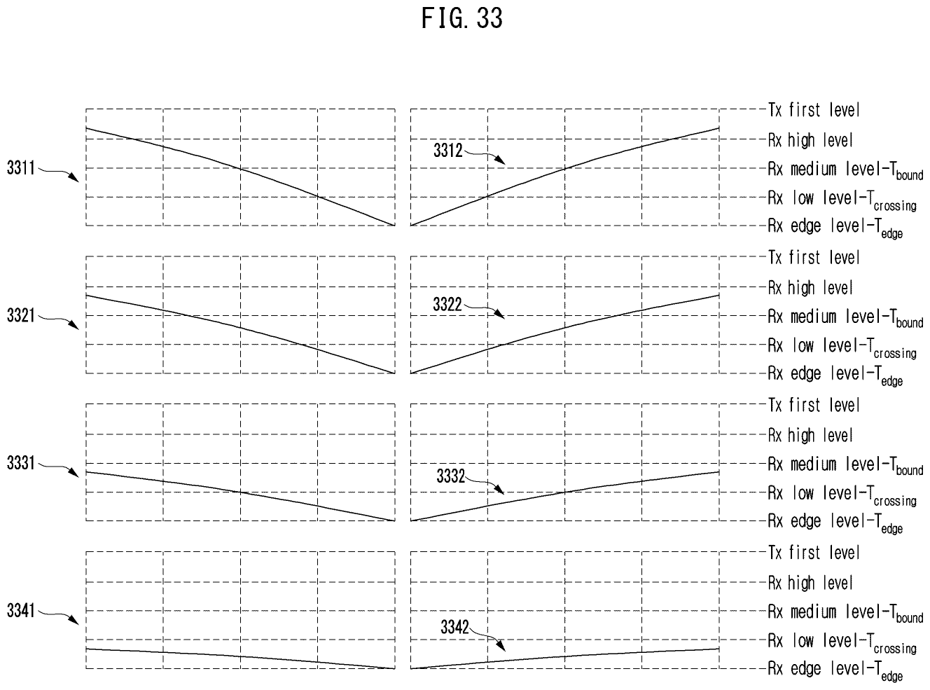

FIG. 33 illustrates patterns for CB and FB qualities of FIGS. 29 and 30.

Referring to FIG. 33, graphs 3311, 3321, 3331, and 3341 of a fourth pattern may represent a decreasing pattern in which a beam quality is best on a far left side. Graphs 3312, 3322, 3332, and 3342 of a fifth pattern may represent an increasing pattern in which a beam quality is best on a far right side. A horizontal axis of the graphs may represent beam spaces. A vertical axis of the graphs may represent beam powers. The graphs 3311 and 3312 may represent cases in which beam powers on the far left and far right sides, respectively, are greater than the high level. The graphs 3321 and 3322 may represent cases in which beam powers on the far left and far right sides, respectively, are positioned between the medium level and the high level. The graphs 3331 and 3332 may represent cases in which beam powers on the far left and far right sides, respectively, are positioned between the low level and the medium level. The graphs 3341 and 3342 may represent cases in which beam powers on the far left and far right sides, respectively, are positioned between the edge level and the low level.

In FIGS. 31 to 33, the respective beam patterns may be classified into cases in which the highest beam quality is greater than the high level, positioned between the high level and the medium level, positioned between the medium level and the low level, and positioned between the low level and the edge level. The best beam quality may be determined by a distance between a TRP and a terminal in a Line Of Sight (LOS) environment. Through the above patterns, a rough location of the terminal may be identified. When pattern information of a current TRP is combined with pattern information of other TRPs located at different locations, a more detailed location of the terminal may be determined. When a beam power of the terminal is positioned between the medium level and the low level, or between the low level and the edge level, inter-cell beam selection may be performed, and ICM may be executed.

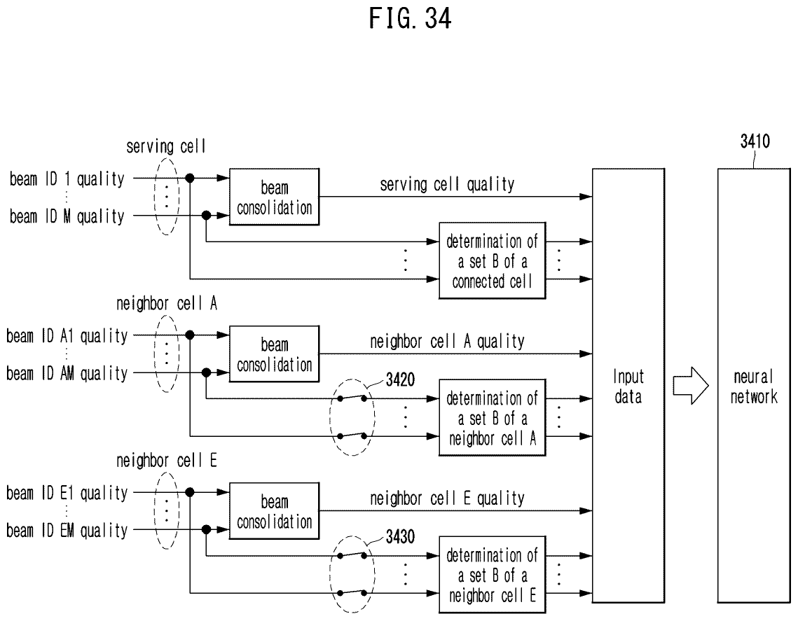

FIG. 34 is a conceptual diagram illustrating an AI/ML model for ICM.

Referring to FIG. 34, a terminal-based neural network model (AI/ML model) may be located on a terminal side. The neural network model may predict an optimal beam set (i.e. set A), as an optimal beam set at a certain future time considering beam quality and signal delay in the spatial domain. When the neural network model predicts one optimal beam at a certain future time, the terminal may determine whether the beam belongs to a currently connected (i.e. serving) cell (i.e. whether the beam selection is an intra-cell beam selection). For prediction of the neural network model, which input data is to be input to the neural network model may be important.

When the optimal beam is an intra-cell beam, the terminal may determine whether the optimal beam is a beam of the current serving cell again. When the optimal beam matches a beam of the current serving cell, the terminal may not perform an action. When the optimal beam does not match a beam of the current serving cell, the terminal may trigger beam switching. When the optimal beam is not an intra-cell beam (i.e. when the optimal beam is an inter-cell beam), the terminal may trigger ICM. Depending on which one of an ICM-handover (basic), an ICM-handover (conditional), or a cell switch (LTM) is used and depending on which one of a terminal-side model or a network-side model is used, signaling actions triggered may differ as shown in Table 6.

TABLE 6

| | Terminal-sided model | Network-sided model |
|---|---|---|
| | Trigger signaling | Trigger signaling |
| | [Action] | [Action] |
| ICM-handover | L3 RRC measurement report | L3 RRC |
| (basic) of FIGS. | (AI/ML mobility aspect | RRCConnectionReconfiguration |
| 13 and 14 | information configuration) | (AI/ML mobility aspect |
| | | information configuration) |
| ICM-handover | L1 reserved PRACH | L2 RAR |
| (conditional) of | (AI/ML mobility aspect time | (AI/ML mobility aspect time |
| FIGS. 15 and 16 | adjustment) | adjustment) |
| ICM-cell switch | L1 measurement report | L2 cell switch command |
| (LTM) of FIGS. | (Reporting beam limitation | (MAC_CE) |
| 17 and 18 | and time adjustment) | (Time adjustment) |

Until the ICMs of FIGS. 13 to 18 in Table 6 are performed, exchange of basic information before a terminal is connected (i.e. when the terminal is in an idle state) and after the terminal is connected (i.e. when the terminal is in a connected state) may be as follows.

When the terminal is in the idle state, the network may transmit to the terminal, through system information, at least one of a number of CBs per current serving cell and per neighbor cell, an effective beam width of a CB, a beam sweeping direction (right or left), a CB burst interval, or a CB group interval. The terminal may receive, through system information from the network, at least one of the number of CBs per current serving cell and per neighbor cell, the effective beam width of a CB, the beam sweeping direction (right or left), the CB burst interval, or the CB group interval.

When the terminal is in the connected state, the network may deliver information to the terminal through a dedicated channel between the terminal and the network. The information may include at least one of a number of FBs per current serving cell and per neighbor cell, an effective beam width of an FB, a beam sweeping direction (right, left), an FB burst interval, or an FB group interval.

In preparation stages of ICMs in the three handover/cell switch cases of Table 6, basic information exchange may be performed. For example, when the terminal is in the connected state, information may be delivered through a dedicated channel between the terminal and the network. For example, the network may transmit an RRC connection reconfiguration (i.e. measurement control information) message to the terminal. The terminal may receive the RRC connection reconfiguration message from the network. AI/ML model-related measurement control information may include an AI/ML model type (one of a terminal-sided model, a network-sided model, or a two-sided model) and beam level information. Among the model types, optionally, an internal neural network type (A, B, C, D, E, etc.) may be applied to the terminal-sided AI/ML model for ICM. As an essential element among types of beam levels, T_{bound} may be present. As optional elements among the types of beam levels, at least one of T_{edge}, T_{low}, T_{medium}, T_{high}, or Tₜₓ may be present.

The terminal may receive the message from the network. The terminal may input the model type information into an ICM AI/ML processing module. The model type information may be information indicating whether the AI/ML model is a terminal-sided model, a network-sided model, or a two-sided model.

When the AI/ML model is a terminal-sided model, the terminal may optionally select one of internal neural network (In-NN) types A, B, C, D, or E of the terminal-sided AI/ML model for ICM. In other words, inputs, outputs, and hidden layers may be differently configured according to each internal neural network type. For example, A may be a CNN. B may be an RNN. C may be a hybrid CNN+RNN (LSTM).

T_{bound}, which is essential information among the beam level information, may serve as a comparison criterion for individual beam qualities or cell qualities measured at the terminal. The terminal may implement the AI/ML model such that only intra-cell beam selection is performed when a beam power of a serving cell is greater than T_{bound}. The terminal may implement the AI/ML model such that both inter-cell beam selection and intra-cell beam selection are performed when a beam power of the serving cell is smaller than T_{bound}. The terminal may implement the AI/ML model such that inter-cell beam selection is performed when a power of a neighbor beam of a neighbor cell is greater than T_{bound}.

The network may optionally provide the terminal with additional information related to detailed power information corresponding to at least one of T_{edge}, T_{low}, T_{medium}, T_{high}, or Tₜₓ (transmission at the TRP) power as the beam level information. The terminal may determine intra-cell beam selection and inter-cell beam selection more precisely by using the detailed power information. Through individual beam measurements of the serving cell and neighbor cells of the terminal, approximate information on an approximate location of the terminal and movement of the terminal may be estimated. The detailed power levels may be classified more diversely.

Specific contents of Table 6 may be as follows. Referring to Table 6 and FIG. 13 together, when the AI/ML model is a terminal-sided model, trigger signaling (action) may be an L3 RRC measurement report (MR). When the terminal receives the AI/ML model-related measurement control information in the ICM preparation stage, information in the measurement report may differ according to the ICM AI/ML model type.

For example, the terminal may receive, as measurement control information, information indicating that the ICM AI/ML model type is a terminal-sided model. The measurement report transmitted by the terminal to the network may include at least one of the ICM AI/ML model type, a predicted cell ID, a predicted beam set A (one or more), or an activation time (a current or future time (system frame number (SFN))). The network may receive measurement report information through the MR from the terminal. The network may determine whether there is any issue with the cell and beam set A predicted by the terminal-sided model. When the network determines that there is no issue with the predicted cell and beam set A, the network may execute ICM (handover (basic)). When the optimal beam set A output by the terminal-sided AI/ML model corresponds to a beam set of a neighbor cell, the terminal may include an activation time in the MR by considering at least one of a predicted future time and a signaling delay time of the MR. When the activation time is a current time, the network may execute ICM immediately upon receiving the measurement report. When the activation time is a future time, the network may execute ICM at the corresponding future time.

For example, the terminal may receive, as measurement control information, information indicating that the ICM AI/ML model type is a network-sided model. The measurement report transmitted by the terminal to the network may include at least one of the ICM AI/ML model type, a measured cell ID, and a cell quality. The measured cell ID and the cell quality may include corresponding optimal beam quality and pattern information such as those of FIGS. 31 to 33. For example, the network may receive at least one of the information through the measurement report from the terminal. The network may obtain a predicted cell and beam set A through the AI/ML model of the network. The terminal may transmit information for the network-sided AI/ML model of the network to determine (predict) the cell and set A to the network. The network may receive, from the terminal, the information for the AI/ML model to determine (predict) the cell and beam set A. The terminal may periodically transmit measurement report messages to the network. The terminal may transmit a measurement report message to the network when a beam power pattern changes, in addition to the periodic time points. For example, the terminal may report to the network with respect to twenty types of patterns corresponding to five pattern types and power levels as shown in FIGS. 31 to 33. For example, when the highest beam power in the current serving cell is between the medium level and the low level, and when the highest beam power of a neighbor cell corresponds to one of all power level types of FIGS. 31 to 33, the terminal may report a pattern and a power change to the network. The terminal may report changes to the network periodically or whenever there is a change in pattern and power. When a beam power of the serving cell or a beam power of the neighbor cell is positioned between T_{bound} and T_{edge}, the terminal may operate in various forms, such as restricting processing for all corresponding cells or for specific filtered cells according to predefined criteria.

Referring to Table 6 and FIG. 14 together, when the AI/ML model is a network-sided model, trigger signaling (action) may be an L3 RRC connection reconfiguration message (handover command message). The RRC connection reconfiguration message may include the same information as that of the existing RRC reconfiguration message after ICM decision. The RRC connection reconfiguration message may include information indicating whether the AI/ML model for ICM is located on the terminal side or on the network side. In other words, the RRC connection reconfiguration message may include information indicating whether the ICM decision is by the terminal-sided model as in FIG. 13, or by the network-sided model as in FIG. 14. The RRC connection reconfiguration message may further include an activation time (a current or future time (SFN)). For example, when the ICM decision is by the network-sided model as in FIG. 14, the network-sided model may predict a neighbor cell and a future beam time. The network may transmit a handover command message to the terminal by considering signaling delay based on the future beam time. The terminal may receive the handover command message from the network and perform ICM. For example, the network may generate a handover command message including an SFN of the activation time based on the future beam time. The network may transmit the handover command message including the SFN of the activation time to the terminal. The terminal may receive the handover command message including the SFN of the activation time from the network. The network may delay an ICM time at the terminal by using the SFN of the activation time in the handover command message.

Referring to Table 6 and FIG. 15 together, when the AI/ML model is a terminal-sided model, the trigger signaling (action) may be an L1 reserved PRACH. During a CHO process, the network may transmit information on candidate cells related to ICM to the terminal. The terminal may receive, from the network, the information on the candidate cells related to ICM. There may be a reserved PRACH individually associated with each of the candidate cells. The terminal-sided AI/ML model may determine a current beam set A (i.e. current and future spatial and temporal beam(s)). When the beam set A is a beam set of a neighbor cell, the terminal may trigger ICM (Handover-CHO) by transmitting, to the network, an L1 reserved PRACH associated with the corresponding neighbor cell. The terminal may consider a delay of the PRACH based on a predicted beam quality at a specific future time. The terminal may adjust a transmission time of the reserved PRACH so that the network can perform a next action at a specific future time.

Referring to Table 6 and FIG. 16 together, when the AI/ML model is a network-sided model, the trigger signaling (action) may be an L2 RAR. During a CHO process, the network may transmit information on candidate cells related to ICM to the terminal. The terminal may receive, from the network, the information on the candidate cells related to ICM. There may be a reserved PRACH individually associated with each of the candidate cells. The network may be aware, in the preparation stage (e.g. S1210 of FIG. 12), of whether the reserved PRACH has been determined by the terminal based on output data of the terminal-sided model or whether the network-sided model needs to determine a current and future beam set A.

For example, when the best cell and the best beam set A have been determined by the terminal-sided model, the network may immediately transmit, to the terminal, an RAR in response to the terminal's PRACH. The terminal may receive, from the network, the RAR. When the current beam set A (i.e. current and future spatial and temporal beam(s)), which is output data of the terminal-sided model, is for a neighbor cell, the terminal may trigger ICM (handover-CHO) by transmitting, to the network, an L1 reserved PRACH associated with the neighbor cell.

For example, when the network-sided model needs to determine the best cell and the best beam set A, the network may determine whether to perform a next procedure based on the reserved PRACH received from the terminal and various information (e.g. L1 measurement reports and L3 RRC measurement reports of the terminal). The next procedure may be that the network transmits, to the terminal, the RAR. The network may not transmit, to the terminal, a response to the PRACH based on the PRACH and the various information. For example, the network may determine whether a cell corresponding to the beam set A, which is the output of the network-sided model, matches a cell corresponding to the PRACH received from the terminal. When the cell corresponding to the beam set A matches the cell corresponding to the received PRACH, the network may immediately transmit, to the terminal, an L2 RAR. When the cell corresponding to the beam set A matches the cell corresponding to the received PRACH, the network may also adjust a timing of the RAR by considering a signal delay based on a future time determined in the network. A policy in a case where the AI/ML model exists in the network may conflict with an existing CHO policy. This is because, in the existing CHO concept, when the network transmits information on multiple candidate cells to the terminal, the terminal selects a target cell. In the present disclosure, the network may immediately approve the reserved PRACH selected by the terminal. Alternatively, in the present disclosure, the network may approve or reject the PRACH by comparing the cell corresponding to the output of the network-side model with the cell corresponding to the reserved PRACH. When the network transmits, to the terminal, a response to the PRACH, the network may also adjust a timing of the L2 RAR.

Referring to Table 6 and FIG. 17 together, when the AI/ML model is a terminal-sided model, the trigger signaling (action) may be an L1 measurement report. When the output of the terminal-sided model is a current and future beam set A for a neighbor cell, the terminal may trigger ICM (cell switch-LTM) through the L1 measurement report. When there are multiple current and future beam sets A, the terminal may transmit, to the network, the L1 measurement report only for a predetermined number of beams with the highest probabilities among the multiple beam sets A. For example, the predetermined number may be at least one of one, two, or three. When the terminal performs ICM trigger based on the output of the terminal-sided model, the terminal may trigger ICM through limited reporting of the neighbor cell and the beams in the L1 measurement report.

Referring to Table 6 and FIG. 18 together, when the AI/ML model is a network-sided model, the trigger signaling (action) may be an L2 cell switch command through a MAC CE. The network-sided model may determine a current and future beam set A. When the beam set A is for a neighbor cell, the network may trigger ICM (cell switch-LTM) through an L2 cell switch command message. The network may utilize, as input for the network-sided model, L1 measurement reports received from the terminal and various other measurement information. The network may immediately transmit, to the terminal, an L2 cell switch command message based on a future beam set A, which is output data of the network-side model. The network may also transmit, to the terminal, the L2 cell switch command message at an appropriate time by considering a signaling delay based on the future beam set A, which is the output data of the network-sided model.

Referring again to FIG. 34, a neural network of the terminal side may have a hybrid structure combining a CNN and an RNN. The terminal may or may not input, to the neural network, a cell quality of a connected cell (i.e. serving cell) and cell qualities of neighbor cells A to E. The terminal may obtain the cell quality through association (consolidation) of beams in the corresponding cell. The terminal may use, as input of the neural network, quality values of all beams belonging to the corresponding cell, or may select a beam set B corresponding to a part of all beams belonging to the corresponding cell and use the selected beam set B as input of the neural network. The beam set B may include, for example, two or three beams. The terminal may use actual quality values as quality values for the beam set B of each cell. The terminal may use very low virtual quality values as quality values for beams that are not included in the beam set B of the corresponding cell.

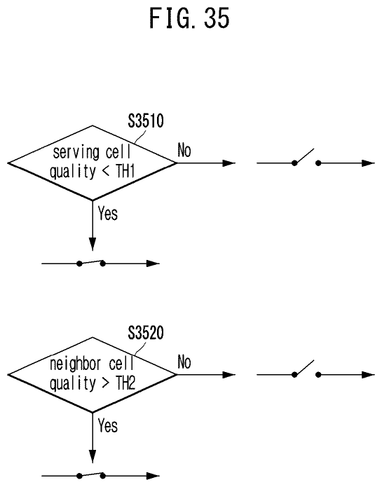

FIG. 35 is a conceptual diagram illustrating a structure of switches in FIG. 34.

Referring to FIG. 35, on/off states of switches 3420 may be determined based on results according to step S3510. For example, when a quality of a connected cell (i.e. serving cell) is greater than a first threshold TH1 (e.g. T_{bound}), the terminal may not use, as input of the neural network, at least one of a neighbor cell quality, all beams belonging to the neighbor cell, or the beam set B, or may apply very low virtual quality values as input of the neural network. By not using the beam set B as input of the neural network or by using very low virtual quality values, the terminal may operate the terminal-sided model to perform only intra-cell beam selection.

For example, when the quality of the serving cell is lower than the first threshold TH1, the terminal may use, as input data of the neural network, at least one of actual value(s) for one or two neighbor cells having the highest quality, actual value(s) for a part of beam qualities of each neighbor cell, a very low virtual value for a part of beam qualities of each neighbor cell, actual values for all beam qualities of each neighbor cell, or a very low virtual value for all beam qualities of each neighbor cell. The terminal may input the input data to the neural network so that the neural network performs inter-cell beam selection.

Additionally, on/off states of switches 3430 may be determined based on results according to step S3520. For example, when a quality of a neighbor cell is greater than a second threshold TH2 (e.g. T_{crossing} Or T_{edge}), the terminal may use, as input data of the neural network, at least one of the corresponding neighbor cell quality, measurement values of all beam qualities belonging to the corresponding cell, a lowest virtual value of all beam qualities belonging to the corresponding cell, measurement values of a part (beam set B) of beam qualities belonging to the corresponding cell, or a lowest virtual value of a part of beam qualities belonging to the corresponding cell. The neural network may receive the input data and perform inter-cell beam selection.

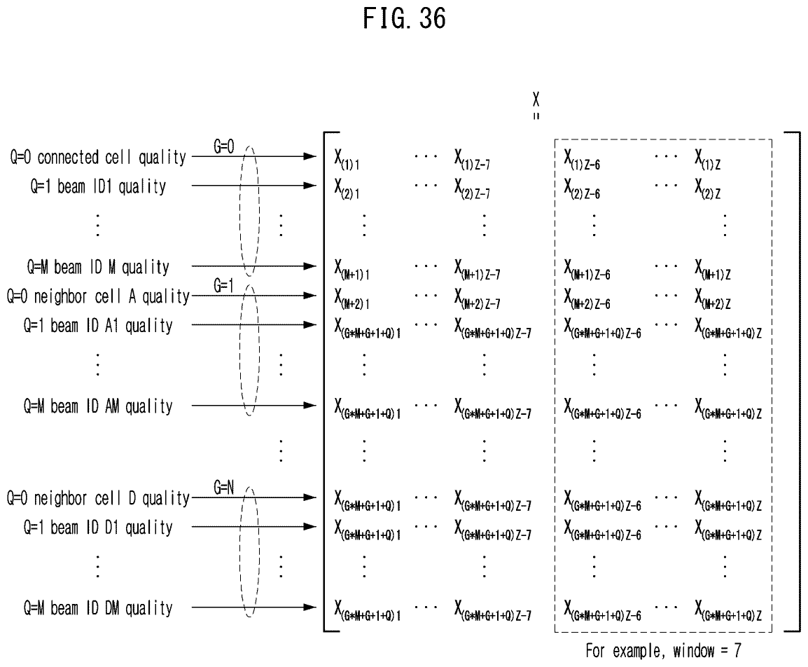

FIG. 36 is a conceptual diagram illustrating input data of a terminal-sided model.

Referring to FIG. 36, input data of the terminal-sided model may be the same as an X matrix. For one cell, a cell quality may be defined as Q=0 (index). When there are a total of M beams in the corresponding cell, a quality of a first beam may be defined as Q=1, and a quality of an M-th beam may be defined as Q=M. Quality values for one cell and all beams belonging to the corresponding cell may be defined as a group (G). For example, a currently connected cell (i.e. serving cell) may be indexed as G=0, and neighbor cells may be indexed as G=1 to G=N.

Each index of Q and G may appear as a column in the X matrix in a certain time duration, and characteristics of beam instances in the time domain may be reflected. Rows in the X matrix may represent unique IDs of cells and/or beams, and characteristics in the spatial domain may be included through each row. In other words, when the X matrix is for CB, characteristics of beam instances in the spatial domain (e.g. characteristics such as those in FIG. 24) may be reflected in rows of the X matrix, and characteristics of beam instances in the time domain (e.g. characteristics such as those in FIG. 25) may be reflected in columns of the X matrix. When the X matrix is for FB, characteristics of beam instances in the spatial domain (e.g. characteristics such as those in FIG. 26) may be reflected in rows of the X matrix, and characteristics of beam instances in the time domain (e.g. characteristics such as those in FIG. 27) may be reflected in columns of the X matrix.

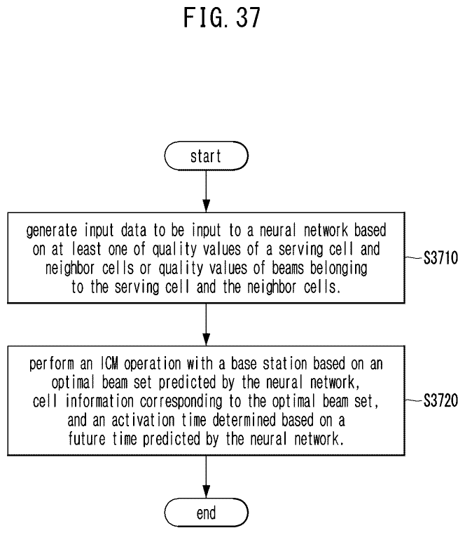

Input data of the terminal-side model may be beam qualities. The beam quality may be scaled to a value between 0 and 1. When measurement values for beam qualities are not considered at all or are excluded for inter-cell beam selection, the terminal may use the lowest value as a value of the beam quality. The lowest value may be, for example, 0. FIG. 37 is a flowchart illustrating a predictive handover procedure using an AI/ML model.

Referring to FIG. 37, the terminal may generate input data to be input to a neural network (i.e. AI/ML model) based on at least one of quality values of a serving cell and neighbor cells or quality values of beams belonging to the serving cell and the neighbor cells (S3710). The terminal may perform an ICM operation with the base station based on an optimal beam set predicted by the neural network, cell information corresponding to the optimal beam set, and an activation time determined based on a future time predicted by the neural network (S3720). The optimal beam set may include an optimal beam in the current spatial domain and an optimal beam in the future time domain.

Quality values of beams belonging to the serving cell and the neighbor cells may be actual quality values of at least some beams among all beams belonging to the serving cell and the neighbor cells. Virtual quality values may be applied as quality values for the remaining beams excluding at least some beams. When a quality value of at least one cell among the serving cell and the neighbor cells is greater than a predetermined threshold for beam power, a predetermined value may be applied as at least one of the quality value of the neighbor cell or quality values of at least some beams belonging to the neighbor cell. For example, when the quality value of the serving cell is greater than a predetermined threshold (e.g. a first threshold TH1), the predetermined value may be a very low virtual value. When the quality of a neighbor cell is greater than a predetermined threshold (e.g. a second threshold TH2), the predetermined value may be at least one of a measurement value for beam quality or a lowest virtual value.

For example, ICM may be performed through a basic handover scheme. When the neural network operates on the terminal, the terminal may transmit, to the base station, type information of the neural network (e.g. information on whether the neural network is a terminal-sided neural network or a base station-sided neural network), the predicted optimal beam set, cell information corresponding to the optimal beam set, and the activation time. The base station may receive, from the terminal, the type information of the neural network, the predicted optimal beam set, the cell information corresponding to the optimal beam set, and the activation time. When the cell information received from the terminal is information on a neighbor cell, the base station may generate a command message for an ICM operation. The base station may transmit the command message to the terminal based on the activation time. The terminal may receive, from the base station, the command message.

For example, ICM may be performed through a basic handover scheme. When the neural network operates on the base station, the terminal may transmit, to the base station, type information of the neural network, information on measured cells including the serving cell and neighbor cells, quality values of beams belonging to the measured cells, and a beam power pattern to generate input data for the neural network. The base station may receive, from the terminal, the type information of the neural network, the information on the measured cells including the serving cell and the neighbor cells, the quality values of the beams belonging to the measured cells, and the beam power pattern. The base station may generate input data for the neural network based on the information on the measured cells, the quality values belonging to the measured cells, and the beam power pattern. The base station may predict an optimal beam set by using the neural network. When cell information corresponding to the optimal beam set is information on a neighbor cell, the base station may generate a command message for an ICM operation including the type information of the neural network. The base station may determine a transmission time of the command message based on the activation time for the optimal beam set and signaling delay time of the ICM command message. The base station may transmit the command message to the terminal at the determined transmission time. The terminal may receive, from the base station, the command message.

For example, ICM may be performed through a conditional handover scheme. When the neural network operates on the terminal, and when the cell information corresponding to the optimal beam set is information on a neighbor cell, the terminal may transmit, to the base station, a reserved PRACH preamble corresponding to the neighbor cell. The base station may receive the reserved PRACH preamble. The base station may generate a command message (e.g. RAR) for an ICM operation based on the reserved PRACH preamble. The base station may transmit the command message to the terminal. The terminal may receive, from the base station, the command message.

For example, ICM may be performed through a conditional handover scheme. When the neural network operates on the base station, the terminal may transmit, to the base station, a reserved PRACH preamble. The base station may receive the reserved PRACH preamble. When cell information corresponding to an optimal beam set predicted by the neural network matches cell information corresponding to the PRACH preamble, the base station may determine a transmission time of an RAR based on an activation time and a signaling delay time of the RAR. The base station may transmit the RAR to the terminal at the determined transmission time. The terminal may receive, from the base station, the RAR.

For example, ICM may be performed through a cell switch scheme. When the neural network operates on the terminal, and when the cell information corresponding to the optimal beam set is information on a neighbor cell, the terminal may transmit, to the base station, a measurement report for a predetermined number (e.g. one to three with the highest probability) of beams included in the optimal beam set. The base station may receive the measurement report for the predetermined number of beams.

For example, ICM may be performed through a cell switch scheme. When the neural network operates on the base station, and when the cell information corresponding to the optimal beam set predicted by the neural network is information on a neighbor cell, the base station may generate a command message for an ICM operation. The base station may determine a transmission time of the command message based on an activation time and a signaling delay time of the command message. The base station may transmit the command message to the terminal at the transmission time. The terminal may receive, from the base station, the command message.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner. The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
generating input data to be provided to a neural network based on at least one of quality values of a serving cell and a neighbor cell, or quality values of beams belonging to each of the serving cell and the neighbor cell; and
performing an inter-cell mobility operation with a base station based on an optimal beam set predicted by the neural network using the input data, cell information corresponding to the optimal beam set, and an activation time determined according to a future time predicted by the neural network.

2. The method of claim 1, wherein the quality values of the beams belonging to each of the serving cell and the neighbor cell are actual quality values of at least some beams among all beams belonging to each of the serving cell and the neighbor cell, and virtual quality values are applied as quality values of remaining beams excluding the at least some beams among all the beams.

3. The method of claim 1, wherein when a quality value of at least one cell among the serving cell and the neighbor cell is greater than a predetermined threshold for beam power, a predetermined value is applied as a quality value of at least one of a quality value of the neighbor cell or quality values of at least some beams belonging to the neighbor cell.

4. The method of claim 1, further comprising, when the neural network operates on the terminal,
transmitting, to the base station, type information of the neural network, the cell information, the optimal beam set, and the activation time; and
receiving, from the base station, a command message for the inter-cell mobility operation.

5. The method of claim 1, further comprising, when the neural network operates on the base station,
transmitting, to the base station, type information of the neural network, information on measured cells including the serving cell and the neighbor cell, quality values of beams belonging to the measured cells, and a beam power pattern, for generation of input data of the neural network; and
receiving, from the base station, a command message for the inter-cell mobility operation,
wherein a transmission time of the command message is determined at the base station based on the activation time and a signaling delay time associated with the command message.

6. The method of claim 1, further comprising, when the neural network operates on the terminal, in response to the cell information corresponding to the optimal beam set being information on the neighbor cell, transmitting, to the base station, a reserved physical random access channel (PRACH) preamble corresponding to the neighbor cell,
wherein a transmission time of the reserved PRACH preamble is determined in consideration of the activation time and a transmission delay time associated with the reserved PRACH preamble.

7. The method of claim 1, further comprising, when the neural network operates on the terminal, in response to the cell information corresponding to the optimal beam set being information on the neighbor cell, transmitting, to the base station, a measurement report for a predetermined number of beams included in the optimal beam set.

8. A method of a base station, comprising:
acquiring an optimal beam set predicted by a neural network using input data generated based on at least one of quality values of a serving cell and a neighbor cell or quality values of beams belonging to each of the serving cell and the neighbor cell, cell information corresponding to the optimal beam set, and an activation time determined according to a future time predicted by the neural network; and
performing an inter-cell mobility operation with a terminal based on the optimal beam set, the cell information corresponding to the optimal beam set, and the activation time.

9. The method of claim 8, wherein the quality values of the beams belonging to each of the serving cell and the neighbor cell are actual quality values of at least some beams among all beams belonging to each of the serving cell and the neighbor cell, and virtual quality values are applied as quality values of remaining beams excluding the at least some beams among all the beams.

10. The method of claim 8, wherein when a quality value of at least one cell among the serving cell and the neighbor cell is greater than a predetermined threshold for beam power, a predetermined value is applied as a quality value of at least one of a quality value of the neighbor cell or quality values of at least some beams belonging to the neighbor cell.

11. The method of claim 8, further comprising, when the neural network operates on the terminal,
receiving, from the terminal, the cell information, the optimal beam set, and the activation time;
in response to the cell information being information on the neighbor cell, generating a command message for the inter-cell mobility operation; and
transmitting the command message to the terminal based on the activation time.

12. The method of claim 8, further comprising, when the neural network operates on the base station, before the acquiring of the optimal beam set, the cell information corresponding to the optimal beam set, and the activation time,
receiving, from the terminal, type information of the neural network, information on measured cells including the serving cell and the neighbor cell, quality values of beams belonging to the measured cells, and a beam power pattern; and
generating the input data based on the information on the measured cells, the quality values of beams belonging to the measured cells, and the beam power pattern.

13. The method of claim 8, wherein the performing of the inter-cell mobility operation comprises:
in response to the cell information corresponding to the optimal beam set being information on the neighbor cell, generating a command message for the inter-cell mobility operation;
determining a transmission time of the command message based on the activation time and a signaling delay time associated with the command message; and
transmitting the command message to the terminal at the determined transmission time.

14. The method of claim 8, further comprising, when the neural network operates on the base station,
receiving a reserved physical random access channel (PRACH) preamble from the terminal;
in response to the cell information corresponding to the optimal beam set matching cell information corresponding to the PRACH preamble, determining a transmission time of a random access response (RAR) based on the activation time and a signaling delay time associated with the RAR; and
transmitting the RAR to the terminal at the determined transmission time.

15. A terminal comprising at least one processor, wherein the at least one processor causes the terminal to perform:
generating input data to be provided to a neural network based on at least one of quality values of a serving cell and a neighbor cell, or quality values of beams belonging to each of the serving cell and the neighbor cell; and
performing an inter-cell mobility operation with a base station based on an optimal beam set predicted by the neural network using the input data, cell information corresponding to the optimal beam set, and an activation time determined according to a future time predicted by the neural network.

16. The terminal of claim 15, wherein the quality values of the beams belonging to each of the serving cell and the neighbor cell are actual quality values of at least some beams among all beams belonging to each of the serving cell and the neighbor cell, and virtual quality values are applied as quality values of remaining beams excluding the at least some beams among all the beams.

17. The terminal of claim 15, wherein when the neural network operates on the terminal, the at least one processor causes the terminal to perform:
transmitting, to the base station, type information of the neural network, the cell information, the optimal beam set, and the activation time; and
receiving, from the base station, a command message for the inter-cell mobility operation.

18. The terminal of claim 15, wherein when the neural network operates on the base station, the at least one processor causes the terminal to perform:
transmitting, to the base station, type information of the neural network, information on measured cells including the serving cell and the neighbor cell, quality values of beams belonging to the measured cells, and a beam power pattern, for generation of input data of the neural network; and
receiving, from the base station, a command message for the inter-cell mobility operation,
wherein a transmission time of the command message is determined at the base station based on the activation time and a signaling delay time associated with the command message.

19. The terminal of claim 15, wherein when the neural network operates on the terminal, the at least one processor causes the terminal to perform: in response to the cell information corresponding to the optimal beam set being information on the neighbor cell, transmitting, to the base station, a reserved physical random access channel (PRACH) preamble corresponding to the neighbor cell,
wherein a transmission time of the reserved PRACH preamble is determined in consideration of the activation time and a transmission delay time associated with the reserved PRACH preamble.

20. The terminal of claim 15, wherein when the neural network operates on the terminal, the at least one processor causes the terminal to perform: in response to the cell information corresponding to the optimal beam set being information on the neighbor cell, transmitting, to the base station, a measurement report for a predetermined number of beams included in the optimal beam set.
